(19) United States
(12) Patent Application Publication
(10) Pub. No.: US 2014/0327701 A1
(43) Pub. Date: Nov. 6, 2014

(54) OPERATION APPARATUS AND INFORMATION PROCESSING SYSTEM

(71) Applicant: FUNAI ELECTRIC CO., LTD., Osaka (JP)

(72) Inventor: Yasuo MASAKI, Osaka (JP)

(73) Assignee: FUNAI ELECTRIC CO., LTD., Osaka (JP)

(21) Appl. No.: 14/256,333

(22) Filed: Apr. 18, 2014

(30) Foreign Application Priority Data
May 2, 2013 (JP) 2013-097098
May 2, 2013 (JP) 2013-097164

(51) Int. Cl. G06F 3/041; G06T 11/60

(52) U.S. Cl. CPC G06F 3/041; G06T 11/60
USPC 345/634; 345/173

(57) ABSTRACT

An operation apparatus includes: a touch panel; a coordinate information generation unit which has a plurality of coordinate generation modes including a first coordinate generation mode; a receiving unit which receives an identification operation for switching from a coordinate generation mode to another coordinate generation mode among the coordinate generation modes; and an output unit which outputs the coordinate information generated by the coordinate information generation unit, wherein the coordinate generation unit generates, according to the coordinate generation mode, two-dimensional coordinates on the plane of a touch position in the touch panel screen, and height information in a perpendicular direction with respect to the touch panel screen.

### CROSS REFERENCE TO RELATED APPLICATIONS

The present application is based on and claims priorities of Japanese Patent Application No. 2013-097098 filed on May 2, 2013, and Japanese Patent Application No. 2013-097164 filed on May 2, 2013. The entire disclosures of the above-identified applications, including the specifications, drawings and claims are incorporated herein by reference in their entirety.

### FIELD

The present invention relates to an operation apparatus having a touch panel and an information processing system using the operation apparatus.

### BACKGROUND

Recently, a technique has been developed for setting a touch panel as an operation target and reflecting an operation on a touch panel in a display screen.

Patent Literature 1 discloses a technique that when a finger (fingertip) is opposite to a display screen on which an image indicating an operation key is displayed, a cursor corresponding to a distance between the finger and the display screen is displayed at a position opposite to the finger in the display screen.

### CITATION LIST

### Patent Literature

Patent Literature 1: Japanese Unexamined Patent Application Publication No. 2010-61224

### SUMMARY

### Technical Problem

In the above described technique, however, it is necessary for a user to move a finger while always maintaining the finger in a certain range of heights above the display screen when the user selects and moves an object displayed on the display screen. As described above, operability is not good since the technique requires a skill of moving the finger while maintaining the finger in a certain range of heights above the display screen.

The present invention is conceived to solve the above described problem, and has an object to provide an operation apparatus having good operability and an information processing system using the operation apparatus.

### Solution to Problem

In order to solve the above described problem, an operation apparatus according to an aspect of the present invention includes: a touch panel which has a touch panel screen and detects a coordinate position on a plane touched on the touch panel screen; a coordinate information generation unit configured to generate coordinate information indicating the coordinate position at which the touch was made and has a plurality of coordinate generation modes to use planar coordinate information indicating a coordinate position of a finger of a user on the touch panel screen, the coordinate generation modes including a first coordinate generation mode; a receiving unit configured to receive an identification operation for switching, among the coordinate generation modes, from one of the coordinate generation modes to another; and an output unit configured to output the coordinate information generated by the coordinate information generation unit, wherein the coordinate information generation unit is configured to generate, according to each of the coordinate generation modes, two-dimensional coordinates of a touch position on a plane on the touch panel screen, and height information (Z) in a perpendicular direction with respect to the touch panel screen.

With this configuration, since (i) two-dimensional coordinates on a plane of the touch position in the touch panel screen and (ii) height information (Z) in a perpendicular direction with respect to the touch panel screen while the finger is put on the touch panel are generated according to a coordinate generation mode, the user does not have to move the finger while maintaining the finger in a certain range of heights above the touch panel screen.

Therefore, the user can operate the operation apparatus without paying attention to the distance between the touch panel screen and the finger and without having stress. Accordingly, it is possible to provide the operation apparatus with good operability.

An operation apparatus according to another aspect of the present invention is an operation apparatus including: a touch panel which has a touch panel screen, and has a function of detecting a touch position of a finger of a user on the touch panel screen and a function of detecting height of the finger above the touch panel screen with respect to the touch panel screen; a coordinate information generation unit having (i) a 3D operation mode to generate, as three-dimensional coordinate information, three-dimensional position information of the finger above the touch panel screen, and (ii) a 2D operation mode which includes a plurality of coordinate generation modes to use planar coordinate information indicating a coordinate position of the finger on the touch panel screen without using the three-dimensional position information detected when the finger is above the touch panel screen, the coordinate generation modes including a first coordinate generation mode; an output unit configured to output the coordinate information generated by the coordinate information generation unit; and a receiving unit configured to receive, in the 2D operation mode, an identification operation for switching from one of the coordinate generation modes to another, wherein the coordinate information generation unit is configured to: (i) generate, in the 3D operation mode, a detection position of the finger as three-dimensional coordinates when the finger is in a three-dimensional space within a certain range of heights above the touch panel screen, including a case where the finger touches the touch panel screen; and (ii) generate, in the 2D operation mode, according to each of the coordinate generation modes, two-dimensional coordinates on a plane of a position touched on the touch panel screen, and height information (Z) in a perpendicular direction with respect to the touch panel screen.

With this configuration, when the finger is in a three-dimensional space within a certain range of heights above the touch panel screen, there is a 3D operation mode in which the detection position of the finger is generated as three-dimensional coordinates.

The 3D operation mode, in other words, is a mode in which when the finger is positioned within a certain range of heights above the touch panel screen, three-dimensional position information including (i) planar position information indicating two-dimensional coordinates of the finger in the touch panel screen and (ii) height information indicating the height of the finger above the touch panel screen is outputted to an external operation apparatus. In this mode, the external operation apparatus displays the cursor corresponding to a distance between the finger and the touch panel screen at a coordinate position indicated by the planar position information.

The operation apparatus having this 3D operation mode generates, in a 2D operation mode, two-dimensional coordinates on the plane of a position on which the touch panel is touched and height information (Z) in a perpendicular direction with respect to the touch panel screen according to a coordinate generation mode.

With this, since it is possible to provide the operation apparatus having the above described 2D operation mode and the conventionally existing 3D operation mode, the user can use both the 3D operation mode and the 2D operation mode depending on the case where the operation apparatus is used. Therefore, the operation apparatus has high operability.

Moreover, it is possible that the coordinate information generation unit has at least the first coordinate generation mode and a second coordinate generation mode, the receiving unit is configured to receive a first identification operation for switching from the first coordinate generation mode to the second coordinate generation mode, and the coordinate information generation unit is configured to: provide a positive value in the first coordinate generation mode as the height information (Z); and provide a zero value in the second coordinate generation mode as the height information (Z).

With this configuration, since a positive value is provided as height information (Z) in the first coordinate generation mode and a zero value is provided as height information (Z) in the second coordinate generation mode, it is possible to obtain stereoscopic coordinates and planar coordinates by using a touch panel which can detect a planar coordinate position.

Moreover, it is possible that the coordinate information generation unit has at least the first coordinate generation mode, a second coordinate generation mode, and a third coordinate generation mode, the receiving unit is configured to receive a second identification operation for switching from the first coordinate generation mode to the third coordinate generation mode, and a third identification operation for switching from the third coordinate generation mode to the second coordinate generation mode, and the coordinate information generation unit is configured to: provide a positive value of at least a certain value in the first coordinate generation mode as the height information (Z); provide a zero value in the second coordinate generation mode as the height information (Z); and provide a positive value of less than the certain value in the third coordinate generation mode as the height information (Z).

With this configuration, in the case of the 2D operation mode, a positive value of at least a certain value is provided as height information (Z) in the first coordinate generation mode, a zero value is provided as height information (Z) in the second coordinate generation mode, and a positive value of less than a certain value is provided as height information (Z) in the third coordinate generation mode.

With this configuration, since in the third coordinate generation mode, height information is provided with a value different from that in the first coordinate generation mode and the second coordinate generation mode, the third coordinate generation mode can enter a middle mode between the first coordinate generation mode and the second coordinate generation mode.

Therefore, compared with the case where the first coordinate generation mode is suddenly shifted to the second coordinate generation mode, since the third coordinate generation mode that is a middle mode is interposed between the first coordinate generation mode and the second coordinate generation mode, the user can obtain a fine sense of operation.

Moreover, it is possible that the coordinate information generation unit is configured to, when planar position coordinates of the touch position of the finger with respect to the touch panel are changed within a predetermined set time, shift to a mouse operation mode to generate change amount information indicating a change amount of the planar position coordinates.

With this configuration, when the planar position coordinates of the touch position of the finger with respect to the touch panel screen are changed within a set time, the coordinate information generation unit is shifted to a mouse operation mode to generate the change amount information indicating a change amount in the planar position coordinates.

The above described operation apparatus only outputs two-dimensional position information on the touch panel screen and height information of the finger above the touch panel screen. However, with this configuration, when a significantly accurate pointing operation is necessary, only a change of the touch position of the finger within the set time can lead to a shift to the mouse operation mode. With this, it is possible to provide the user with operability of the accurate pointing operation.

Moreover, it is possible that the coordinate information generation unit is configured to: be in a wait state that is not any of the coordinate generation modes, at least after a start of the operation apparatus; and shift from the wait state to the first coordinate generation mode when, in the wait state, it is detected that the touch panel screen is touched by at least one of a plurality of the fingers

With this configuration, when it is detected that at least one finger touches the touch panel screen in a wait state, the waiting shift is shifted to the first coordinate generation mode. Therefore, when one finger touches the touch panel screen in the wait state, the touch of the finger on the touch panel screen is equal to the existence of the finger above the touch panel screen. With this, even when the touch panel which can only output two-dimensional information is used, it is possible to output three-dimensional information including height information by shifting to the first coordinate generation mode.

Moreover, it is possible that the coordinate information generation unit is configured to enter a wait state when a touch on the touch panel screen is not detected for a certain period of time in one of the first coordinate generation mode, the second coordinate generation mode, and the third coordinate generation mode.

With this configuration, when in any one of the first coordinate generation mode to the third coordinate generation mode, a touch is not detected on the touch panel for a certain period of time, the coordinate information generation unit enters a wait state. Therefore, no special operation is necessary for generating the wait state from any one of the first coordinate generation mode to the third coordinate generation mode. Therefore, it is possible to realize a natural sense of operation.

Furthermore, it is possible that the operation apparatus further includes a first operation key capable of shifting the coordinate information generation unit from the first coordinate generation mode to the second coordinate generation mode, wherein the coordinate information generation unit is configured to shift from the first coordinate generation mode to the second coordinate generation mode when the receiving unit receives an operation of the first operation key as the first identification operation, and shift from the second coordinate generation mode to the first coordinate generation mode when the receiving unit no longer receives the operation of the first operation key.

With this configuration, the operation of the first operation key leads to a shift to the second coordinate generation mode which treats as if the finger were positioned on the touch panel screen, and the cancellation of the operation of the first operation key leads to a shift to the first coordinate generation mode which treats as if the finger were above the touch panel screen.

As described above, since the operation of the first operation key corresponds to the shift to the coordinate generation mode, it is possible to realize a natural sense of operation.

Furthermore, it is possible that the coordinate information generation unit is configured to shift from the first coordinate generation mode to the second coordinate generation mode when in the first coordinate generation mode, as the first identification operation, the touch panel detects a touch for a certain period of time at a same position on the touch panel screen, and to shift from the second coordinate generation mode to the first coordinate generation mode when the touch is canceled.

With this configuration, one of the first coordinate generation mode and the second coordinate generation mode is determined by whether or not there is a continuous touch on the same position in the touch panel screen for a certain period of time. With this, since the coordinate generation mode is changed by the operation having the intention of holding the touch position in the touch panel screen, it is possible to realize a natural sense of operation.

Moreover, it is possible that the first identification operation is a series of operations of continuing to stop the finger of the user at a same position on the touch panel screen, and then cancelling the touch within a certain period of time, followed by touching the touch panel screen, and the coordinate information generation unit is configured to shift from the first coordinate generation mode to the second coordinate generation mode when the receiving unit receives the first identification operation in the first coordinate generation mode, and shift from the second coordinate generation mode to the first coordinate generation mode when the touch is canceled.

With this configuration, the first coordinate generation mode is continued when the finger stops at the same position on the touch panel screen and the touch is being canceled in a subsequently certain period of time, the subsequent touch again leads to a shift to the second coordinate generation mode.

Therefore, since a virtual touch operation is realized in which the finger stops at the same position on the touch panel screen and height information is outputted when the finger touches the touch panel screen in a subsequently certain period of time and the subsequent touch again leads to a shift to a real touch equivalent state in which height information is not outputted, it is possible to realize a more natural sense of operation.

Moreover, it is possible that the first identification operation is a touch operation on the touch panel screen by another finger different from a touching finger which causes a shift to the first coordinate generation mode, and the coordinate information generation unit is configured to: generate the planar coordinate information based on planar coordinates which indicates a touch position of the touching finger which causes a shift to the second coordinate generation mode; shift from the second coordinate generation mode to the first coordinate generation mode by canceling the touch of the touching finger which causes a shift to the second coordinate generation mode; and shift from the second coordinate generation mode to a wait state by canceling, for at least a certain period of time, the touch of the touching finger which causes a shift to the second coordinate generation mode.

With this configuration, the first identification operation is a touch operation on the touch panel screen by another finger different from the touching finger which causes a shift to the first coordinate generation mode. Therefore, it is possible to shift to the second coordinate generation mode by the touch operation by another finger different from the finger while the finger which causes a shift to the first coordinate generation mode is continuously touching.

Accordingly, this is effective when while stopping the finger which causes a shift to the first coordinate generation mode, the user tracks the coordinates of the moving object and wants to change the coordinate generation mode for the coordinates of the object to the touch equivalent state.

Moreover, since the first coordinate generation mode is successively recovered by the cancellation of the touch of the finger which causes a shift to the second coordinate generation mode, it is even more effective when the user continuously tracks the object with the finger which causes a shift to the first coordinate generation mode.

Moreover, it is possible that the coordinate information generation unit is configured to: shift from the first coordinate generation mode to the third coordinate generation mode when in the first coordinate generation mode, as the second identification operation, the touch panel detects a touch for a certain period of time at a same position on the touch panel screen; and shift from the third coordinate generation mode to the first coordinate generation mode when the touch position is changed or when the touch is canceled.

With this configuration, the second identification operation is a touch which continues at the same position in the touch panel screen for a certain period of time. Therefore, since it is possible to switch between the first coordinate generation mode and the third coordinate generation mode by the operation having the intention of having the touch position stop, it is possible to realize a natural sense of operation.

Moreover, it is possible that the coordinate information generation unit is configured to shift from the first coordinate generation mode to the third coordinate generation mode when in the first coordinate generation mode, as the second identification operation, a change of the touch position on the touch panel screen is slowed, and to shift from the third coordinate generation mode to the first coordinate generation mode when a change of the touch position on the touch panel screen is accelerated.

With this configuration, since it is possible to switch between the first coordinate generation mode and the third coordinate generation mode according to a method of making it easier to reflect the intention of the difference of whether the moving speed of the touch position is fast or slow, it is possible to realize a more natural sense of operation.

Furthermore, it is possible that the operation apparatus further includes a second operation key capable of shifting the coordinate information generation unit from the third coordinate generation mode to the second coordinate generation mode, wherein the coordinate information generation unit is configured to shift from the third coordinate generation mode to the second coordinate generation mode when the receiving unit receives an operation of the second operation key as the third identification operation, and to shift from the second coordinate generation mode to the third coordinate generation mode when the receiving unit no longer receives the operation of the second operation key later.

With this configuration, the operation of the second operation key leads to a shift to the second coordinate generation mode which treats as if the finger were positioned on the touch panel screen, and the cancellation of the operation of the second operation key leads to a shift to the third coordinate generation mode that is a middle mode between the first coordinate generation mode and the second coordinate generation mode.

As described above, since the operation of the second operation key corresponds to the shift to the coordinate generation mode, it is possible to realize a natural sense of operation.

Furthermore, it is possible that the coordinate information generation unit is configured to shift from the third coordinate generation mode to the second coordinate generation mode when in the third coordinate generation mode, as the third identification operation, the touch panel detects a touch for a certain period of time at a same position on the touch panel screen, and shift from the second coordinate generation mode to the third coordinate generation mode when the touch is canceled later.

With this configuration, one of the third coordinate generation mode and the second coordinate generation mode is determined by whether or not there is a continuous touch on the same position in the touch panel screen for a certain period of time. With this, since the coordinate generation mode is changed by the operation having the intention of holding the touch position in the touch panel screen, it is possible to realize a natural sense of operation.

Moreover, it is possible that the third identification operation is a series of operations of canceling the touch within a certain period of time, and then touching the touch panel screen again, and the coordinate information generation unit is configured to shift from the third coordinate generation mode to the second coordinate generation mode when the receiving unit receives the third identification operation in the third coordinate generation mode, and then shift from the second coordinate generation mode to the third coordinate generation mode when the touch is canceled later.

With this configuration, the third coordinate generation mode is continued when the finger stops at the same position on the touch panel screen and the touch is being canceled in a subsequently certain period of time, and the subsequent touch again leads to a shift to the second coordinate generation mode.

Therefore, since a virtual touch operation is realized in which the finger stops at the same position on the touch panel screen and height information is outputted when the finger touches the touch panel screen in a subsequently certain period of time and the subsequent touch again leads to a shift to a real touch equivalent state in which height information is not outputted, it is possible to realize a more natural sense of operation.

Moreover, it is possible that the third identification operation is a touch operation on the touch panel screen by another finger different from a touching finger which causes a shift to the first coordinate generation mode and the third coordinate generation mode, and the coordinate information generation unit is configured to: generate the planar coordinate information based on planar coordinates which indicates a touch position of the touching finger which causes a shift to the third coordinate generation mode; shift from the third coordinate generation mode to the first coordinate generation mode by canceling the touch of the touching finger which causes a shift to the third coordinate generation mode; and shift from the third coordinate generation mode to a wait state by canceling, for at least a certain period of time, the touch of the touching finger which causes a shift to the third coordinate generation mode.

With this configuration, the third identification operation is a touch operation on the touch panel screen by another finger different from the touching finger which causes a shift to the third coordinate generation mode.

Therefore, it is possible to shift to the first coordinate generation mode by the touch operation by another finger different from the finger while the finger which causes a shift to the third coordinate generation mode is continuously touching.

Accordingly, this is effective when while stopping the finger which causes a shift to the third coordinate generation mode, the user tracks the coordinates of the moving object and wants to change the coordinate generation mode for the coordinates of the object to the virtual touch equivalent state.

Moreover, since the first coordinate generation mode is successively recovered by canceling the touch of the finger which causes a shift to the third coordinate generation mode, it is even more effective when the user continuously tracks the object with the finger which causes a shift to the third coordinate generation mode.

Moreover, it is possible that the operation apparatus further includes: a display unit; an image output unit configured to output an image displayed on the display unit to an external display apparatus; and a central processing unit (CPU) configured to, when outputting the image by connecting the external display apparatus to the image output unit, superimpose, on the image, a cursor image corresponding to the coordinate generation mode in synchronization with a touch operation on the touch panel screen, and output the image on which the cursor image is superimposed to the external display apparatus, wherein the touch panel screen is transparent, and functions as a touch screen display by integrating with the display unit.

With this configuration, when an image is outputted by connecting the external display apparatus to the image output unit, the cursor image corresponding to the coordinate generation mode is superimposed on the image in synchronization with the touch operation on the touch panel screen. Therefore, the user can feel as if the touch operation on the touch panel screen were being performed on the side of the display apparatus.

Accordingly, it is possible to provide an operation apparatus which makes it possible to touch the finger on the touch panel screen at hand with a natural sense by watching the external display apparatus.

Moreover, it is possible that the operation apparatus further includes: a display unit; an image output unit configured to output an image displayed on the display unit to an external display apparatus; a central processing unit (CPU) configured to, when outputting the image by connecting the external display apparatus to the image output unit, superimpose, on the image, a mouse cursor image in synchronization with a touch operation on the touch panel screen, and output the image on which the mouse cursor image is superimposed to the external display apparatus, wherein the touch panel screen is transparent, functions as a touch screen display and as a touch pad which realizes a mouse operation equivalent function, by integrating with the display unit.

With this configuration, when the image is outputted by connecting the external display apparatus to the image output unit, the mouse cursor image is superimposed on the image in synchronization with the touch operation on the touch panel screen. Therefore, it is possible to move the mouse cursor image by operating the touch panel at hand with a natural sense by watching the external display apparatus.

Moreover, an information processing system according to an aspect of the present invention includes: the above described operation apparatus; a display apparatus; a processing apparatus which converts the coordinate information outputted from the output unit into coordinate information in the display apparatus, and displays a cursor image at a coordinate position indicated by the coordinate information that was converted; and a communication unit configured to communicate at least the coordinate information between the operation apparatus and the processing apparatus, wherein when receiving the coordinate information and the height information (Z) from the output unit, the processing apparatus: displays a first cursor image when the height information (Z) is a positive value of at least a set value; displays a second cursor image when the height information (Z) is a zero value; and displays a third cursor image when the height information (Z) is a positive value of less than the set value.

With this configuration, when height information is a positive value of at least the set value, the first cursor image is displayed. When height information is a zero value, the second cursor image is displayed. When height information is a positive value of less than the set value, the third cursor image is displayed.

With this, it is possible to easily identify that the operation apparatus is in any one of the first coordinate generation mode, the second coordinate generation mode, and the third coordinate generation mode. It is possible for the user to intuitively recognize, by a difference in cursor display, that height coordinates Z are changing according to the user operation although the user is operating on the same touch panel screen.

### Advantageous Effects

According to the present invention, the user can operate the operation apparatus without paying attention to the distance between the touch panel screen and the finger and without having stress.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is a system configuration diagram illustrating an example of an information processing system according to Embodiment 1 of the present invention.

FIG. 2 is a block diagram illustrating an example of functional blocks of an operation apparatus according to Embodiment 1 of the present invention.

FIG. 3 is a diagram illustrating an example of an identification operation table.

FIG. 4 is a block diagram illustrating an example of the functional configuration of a processing apparatus.

FIG. 5 is a diagram illustrating an example of a configuration of a corresponding mode table.

FIG. 6 is a block diagram illustrating an example of the functional configuration of a display apparatus.

FIG. 7 is a flowchart illustrating an example of a basic operation of a coordinate information generation unit of the operation apparatus.

FIG. 8 is a flowchart illustrating a coordinate generation mode shift process performed by a coordinate information generation unit.

FIG. 9 is a flowchart illustrating an example of a basic operation of the processing apparatus.

FIG. 10A is a diagram illustrating an example of an image displayed by the display apparatus.

FIG. 10B is a diagram illustrating an example of a cursor image to be superimposed on the image displayed by the display apparatus.

FIG. 11 is a diagram illustrating an example of a mouse cursor image.

FIG. 12 is a flowchart illustrating an example of a basic operation of a coordinate information generation unit of the operation apparatus according to Embodiment 2 of the present invention.

FIG. 13 is a diagram illustrating an example of a cursor image to be displayed in the display apparatus according to Embodiment 2 of the present invention.

FIG. 14 is a system configuration diagram illustrating an example of an information processing system according to Embodiment 3 of the present invention.

FIG. 15 is a block diagram illustrating an example of functional blocks of an operation apparatus according to Embodiment 3 of the present invention.

FIG. 16 is a diagram illustrating an example of a configuration of an operation mode table.

FIG. 17 is a block diagram illustrating an example of the functional configuration of a relay apparatus.

FIG. 18 is a flowchart illustrating an example of a basic operation of a coordinate information generation unit of the operation apparatus.

FIG. 19 is a flowchart illustrating an example of a basic operation of a coordinate information generation unit of the operation apparatus.

FIG. 20 is a diagram illustrating an example of the functional configuration of a touch panel when the coordinate information generation unit is in a mouse operation mode.

FIG. 21 is a flowchart illustrating another example of a basic operation when the coordinate information generation unit is in a mouse operation mode.

FIG. 22 is a flowchart illustrating a still another example of a basic operation when the coordinate information generation unit is in a mouse operation mode.

FIG. 23 is a flowchart illustrating an example of a basic operation of the CPU.

### DESCRIPTION OF EMBODIMENTS

Hereinafter, embodiments of the present invention will be described with reference to the drawings. It should be noted that each of the embodiments to be described later is a general or specific example. The structural elements, the arrangement and connection of the structural elements, steps, the processing order of the steps etc. shown in the following embodiments are mere examples, and therefore do not limit the scope of the present invention. Therefore, among the structural elements in the following exemplary embodiments, structural elements not recited in any one of the independent claims are described as arbitrary structural elements.

### Embodiment 1

### <Configuration of Information Processing System>

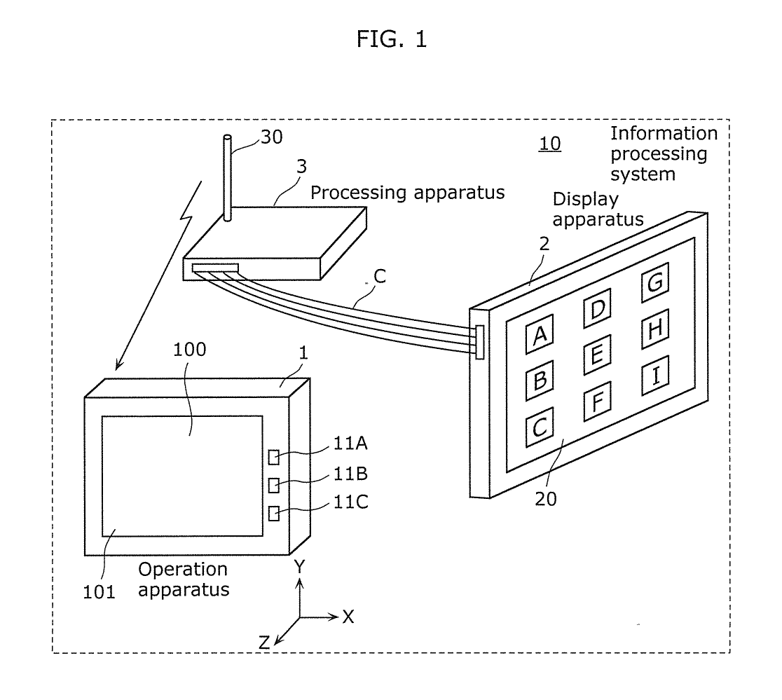

FIG. 1 is a system configuration diagram illustrating an example of an information processing system according to Embodiment 1 of the present invention. An information processing system 10 illustrated in FIG. 1 includes an operation apparatus 1, a display apparatus 2, and a processing apparatus 3. This information processing system 10 is a system which makes the user feel as if the operation of a touch panel 100 in the operation apparatus 1 were performed on a display screen 20 of the display apparatus 2 when the processing apparatus 3 executes an application program previously installed in the processing apparatus 3.

In other words, this information processing system 10 is a system which provides the user with the display screen 20 of the display apparatus 2 as a virtual touch panel.

The operation apparatus 1 includes not only the touch panel 100 but also a first operation key 11A to a third operation key 11C to be described later. The operation apparatus 1, for example, perform the process according to Android (registered trademark) that is one of the platforms.

As described above, the display apparatus 2 includes the display screen 20. The processing apparatus 3, for example, between itself and the operation apparatus 1, performs wireless communication according to Bluetooth (registered trademark) that is one of the near field communication standards, and transmits and receives predetermined information.

Moreover, the processing apparatus 3 is connected to the display apparatus 2 via a cable C, and provides predetermined image information to the display apparatus 2. It should be noted that the processing apparatus 3 and the display apparatus 2 may be able to perform wireless communication between them. Moreover, although in Embodiment 1, the operation apparatus 1 and the processing apparatus 3 are separately provided, the present embodiment is not limited to this example. It is possible that the present embodiment is a single apparatus which includes the functions of the operation apparatus 1 and the processing apparatus 3.

### <Configuration of Operation Apparatus 1>

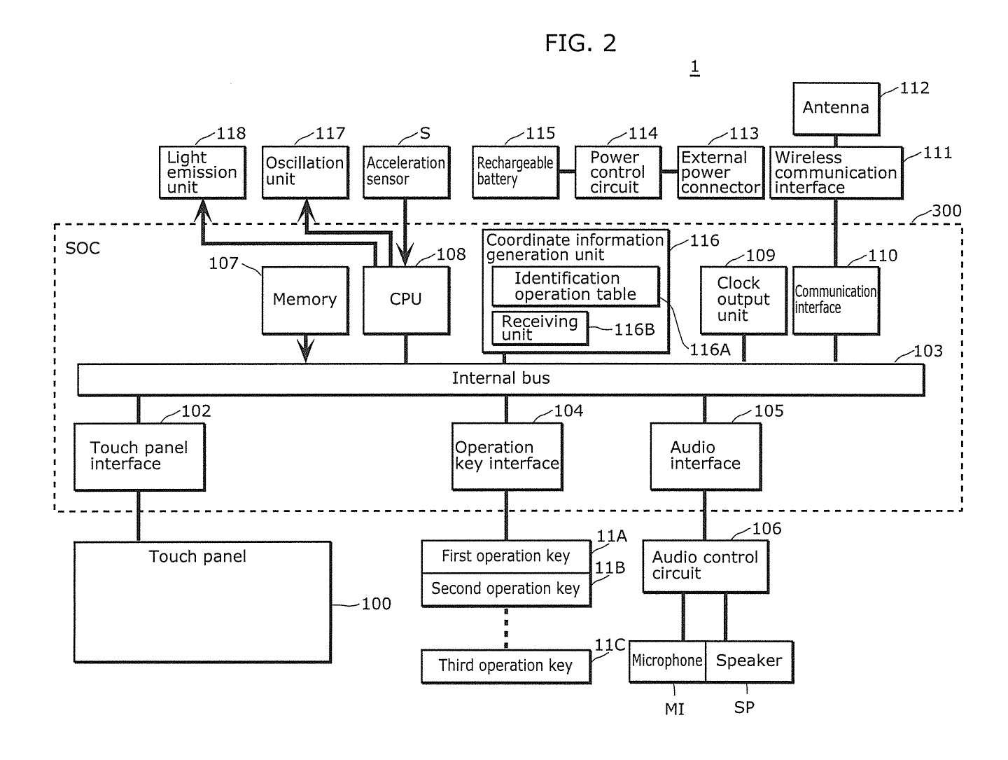

FIG. 2 is a block diagram illustrating an example of functional blocks of an operation apparatus according to Embodiment 1 of the present invention.

The operation apparatus 1, as illustrated in FIG. 2, includes a system-on-a-chip (SOC) 300, a touch panel 100, a first operation key 11A, a second operation key 11B, a third operation key 11C, an audio control circuit 106 which controls a microphone MI and a speaker SP, a wireless communication interface 111, an antenna 112, an external power connector 113, a power control circuit 114, a rechargeable battery 115, an acceleration sensor S, an oscillation unit 117, and a light emission unit 118.

In the SOC 300, the following structural elements are connected to an internal bus 103. The SOC 300 includes a touch panel interface 102, an operation key interface 104, an audio interface 105, a memory 107, a central processing unit (CPU) 108, a clock output unit 109, a communication interface (communication unit, output unit) 110, a coordinate information generation unit 116 including an identification operation table 116A.

The touch panel interface 102 is an interface to connect the touch panel 100 to the SOC 300.

The operation key interface 104 is an interface to connect the first operation key 11A to the third operation key 11C to the SOC 300. The operation key interface 104 receives information indicating that the operation keys 11A to 11C have been operated (for example, information indicating an ON period of signal), and then outputs the information to the CPU 108. The audio interface 105 is an interface to connect the audio control circuit 106 to the SOC 300.

The memory 107 is a storage medium in which various types of control programs necessary for operating this operation apparatus 1 are stored. In the memory 107, as one of the control programs, a program comprising Android (registered trademark) is previously installed.

The CPU 108 performs the function as a control unit by operating through the control program stored in the memory 107, that is, through Android (registered trademark). The clock output unit 109 is a unit which outputs a clock signal to operate the CPU 108.

The communication interface 110 is an interface to connect the wireless communication interface 111 to the SOC 300.

The coordinate information generation unit 116 has the first coordinate generation mode, the second coordinate generation mode, and the third coordinate generation mode. It should be noted that these coordinate generation modes will be described in detail later. Moreover, the coordinate information generation unit 116 includes an identification operation table 116A and a receiving unit 116B.

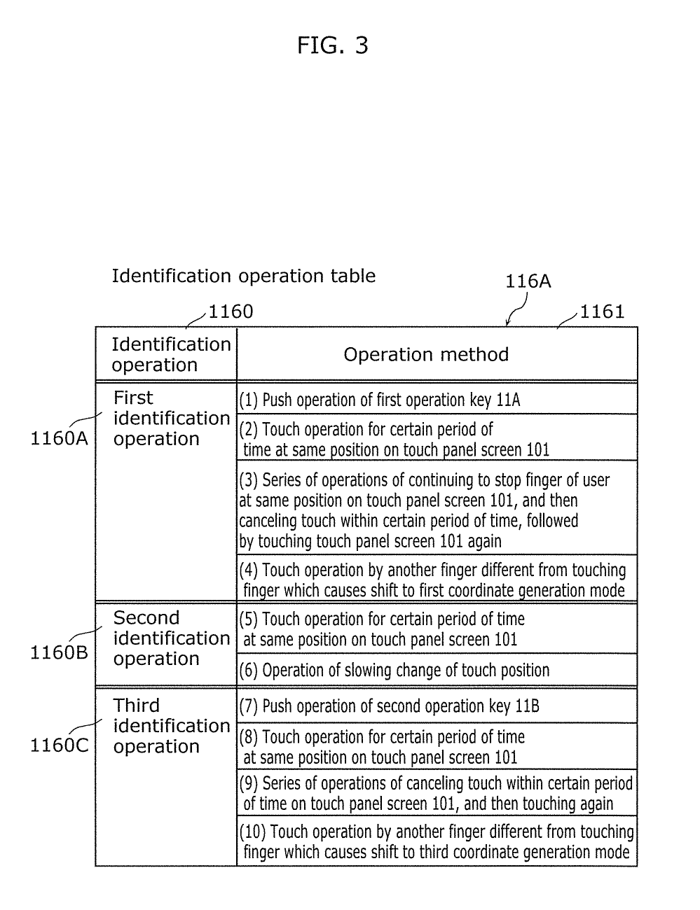

FIG. 3 is a diagram illustrating an example of the identification operation table 116A. The identification operation table 116A stores an identification operation 1160, and an operation method 1161 corresponding to the identification operation 1160.

In Embodiment 1, as the identification operation 1160, a first identification operation 1160A, a second identification operation 1160B, and a third identification operation 1160C are stored.

Then, corresponding to the first identification operation 1160A, (1) “a push operation of the first operation key 11A”, (2) “a touch operation at the same position on the touch panel screen 101 for a certain period of time”, (3) “a series of operations of continuing an operation of stopping the finger of the user on the touch panel screen 101, and then cancelling the touch within a certain period of time, followed by touching the touch panel screen 101 again”, and (4) “a touch operation by another finger different from the touching finger which causes a shift to the first coordinate generation mode” are stored.

Moreover, corresponding to the second identification operation 1160B, (5) “a touch operation which continues for a certain period of time at the same position of the touch panel screen 101”, and (6) “an operation of slowing a change in the touch position in the touch panel screen 101” are stored.

Furthermore, corresponding to the third identification operation 1160C, (7) “a push operation of the second operation key 11B”, (8) “a touch operation for a certain period of time at the same position in the touch panel screen 101”, (9) “a series of operation of canceling the touch on the touch panel screen 101 within the certain period of time, and then touching again”, and (10) “a touch operation by another finger different from the touching finger which causes a shift to the third coordinate generation mode” are stored.

The receiving unit 116B receives the first identification operation, the second identification operation, and the third identification operation that are described later.

The touch panel 100 includes the touch panel screen 101, and detects a planar coordinate position on the touch panel screen 101 touched by the user.

The first operation key 11A is an operation key to perform the first identification operation to be described later. The second operation key 11B is an operation key to perform the second identification operation to be described later. The third operation key 11C is an operation key to perform the selection operation to be described later. It should be noted that although in the present embodiment, a dedicated function is assigned to each of the first operation key 11A to the third operation key 11C, the present invention is not limited to this example. It is possible that a function corresponding to a control program executed by the CPU 108 is assigned to each of the first operation key 11A to the third operation key 11C.

The audio control circuit 106 is a circuit to have a telephone call with a partner (for example, a mobile phone handset) via the microphone MI and the speaker SP. In other words, the operation apparatus 1 also functions as a mobile phone handset.

The wireless communication interface 111 is an interface to perform wireless communication, via the antenna 112, between itself and the operation apparatus 1.

An external power connector 113 receives power supply from a recharger (not illustrated). The power control circuit 114 controls recharge from the recharger to the rechargeable battery 115.

The acceleration sensor S includes, for example, a three-axis acceleration sensor, and outputs orientation information indicating the orientation of the operation apparatus 1 to the CPU 108.

The oscillation unit 117, for example, comprises a motor and a piezoelectric element, and oscillates at a predetermined timing. The light emission unit 118, for example, comprises a light-emitting diode, and emits light at a predetermined timing. It should be noted that an example of the predetermined timing will be described later.

### <Configuration of Processing Apparatus 3>

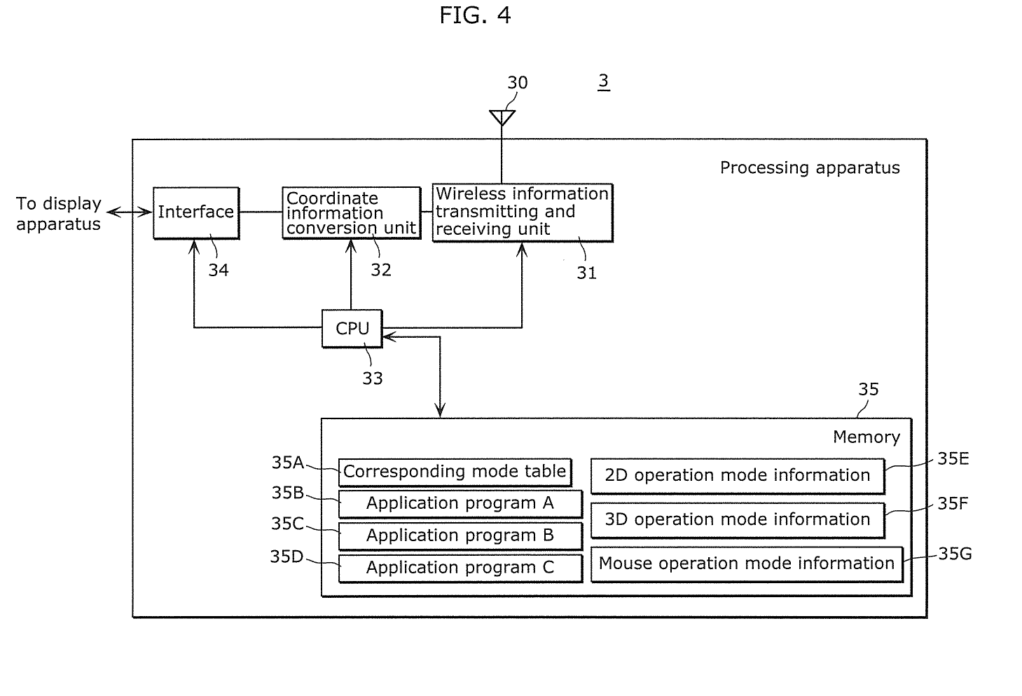

The display apparatus 2 displays an image provided by the processing apparatus 3. To perform the function, the processing apparatus 3 is configured as follows. FIG. 4 is a block diagram illustrating an example of the functional configuration of the processing apparatus 3.

The processing apparatus 3 includes a wireless information transmitting and receiving unit (communication unit) 31, a coordinate information conversion unit 32, a CPU 33, an interface 34, and a memory 35.

The wireless information transmitting and receiving unit 31 is connected to the antenna 30, and is a unit which transmits and receives various information items via wireless communication with the operation apparatus 1. It should be noted the types of information will be described later.

The coordinate information conversion unit 32 is a unit which converts coordinate information generated by the operation apparatus 1 into coordinate information in the display apparatus 2. To perform the function, the coordinate information conversion unit stores association between coordinate information by the operation apparatus 1 and coordinate information in the display apparatus 2. The CPU 33 controls this processing apparatus 3 according to a control program stored in the memory 35, for example, Android (registered trademark).

The interface 34 is an interface which connects the display apparatus 2 to the processing apparatus 3. The memory 35 includes various control programs necessary to operate this processing apparatus 3, a corresponding mode table 35A, application programs 35B to 35D, 2D operation mode information 35E, 3D operation mode information 35F, and mouse operation mode information 35G. It should be noted that the 2D operation mode information 35E, the 3D operation mode information 35F, and the mouse operation mode information 35G will be described in detail later.

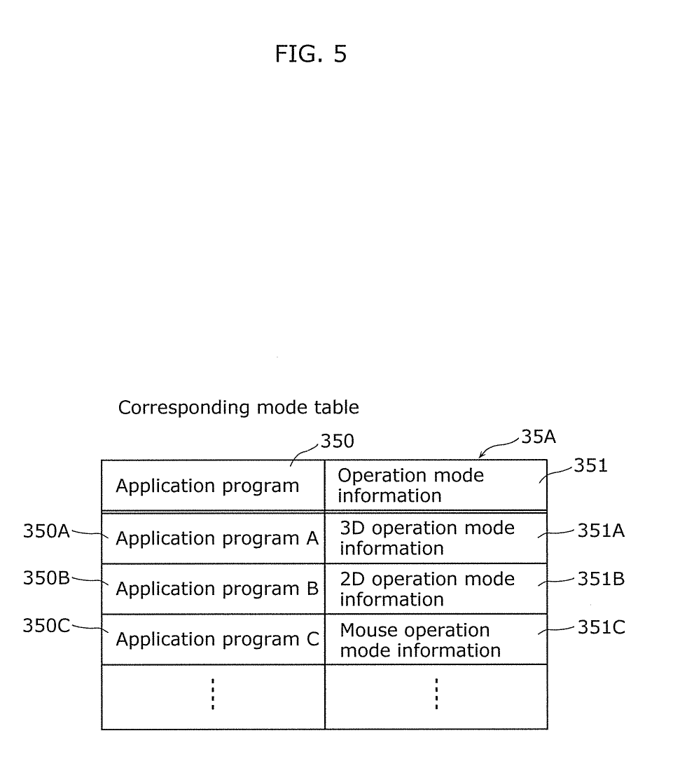

FIG. 5 is a diagram illustrating an example of a configuration of a corresponding mode table. The corresponding mode table 35A stores operation mode information 351 corresponding to an application program 350. In this example, 3D operation mode information 351A is stored corresponding to an application program 350A, 2D operation mode information 351B is stored corresponding to an application program 350B, and mouse operation mode information 351C is stored corresponding to an application program 350C. It should be noted that the 3D operation mode information 351A, the 2D operation mode information 351B, and the mouse operation mode information 351C will be described in detail later.

### <Configuration of Operation Apparatus 2>

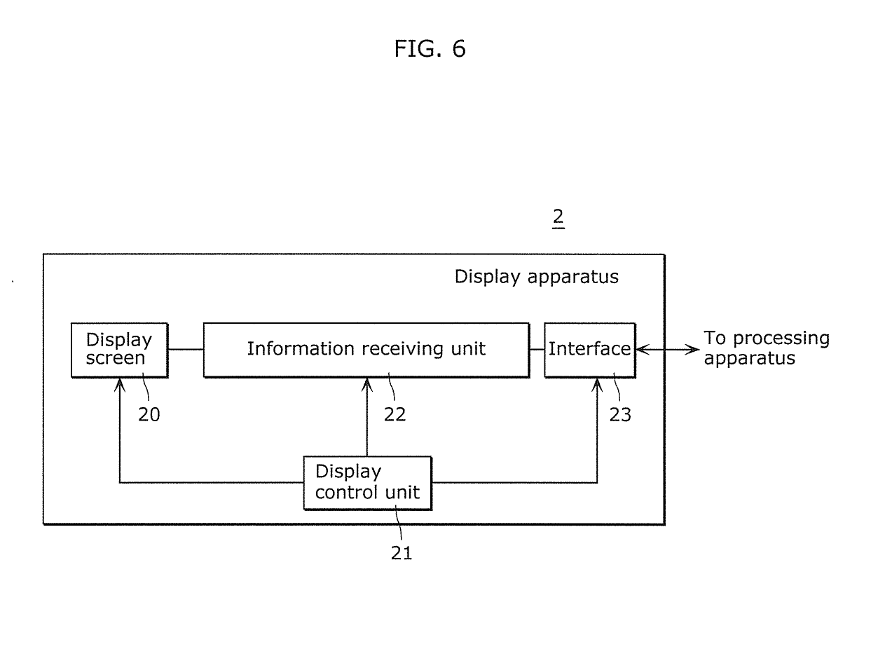

FIG. 6 is a block diagram illustrating an example of the functional configuration of the display apparatus 2. The display apparatus 2 includes a display screen 20, a display control unit 21, an information receiving unit 22, and an interface 23. The display screen 20 comprises, for example, a liquid crystal display. The display control unit 21 controls a display of an image on the display screen 20. For example, the display control unit 21 displays an image on the display screen 20 by controlling orientations of liquid crystal molecules. The information receiving unit 22 receives various information items transmitted via the interface 23 from the processing apparatus 3. It should be noted the types of information will be described later.

### <Operation of Operation Apparatus 1>

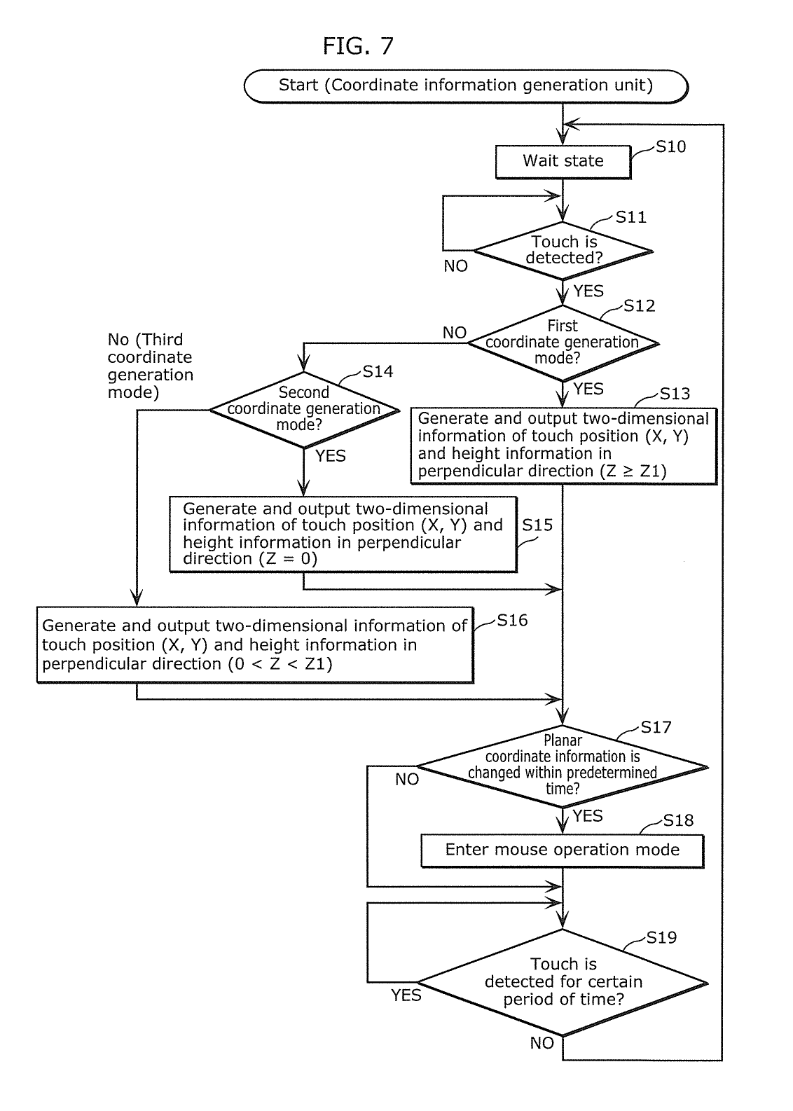

FIG. 7 is a flowchart illustrating an example of a basic operation of the coordinate information generation unit 116 of the operation apparatus 1. First, when the operation apparatus 1 is turned ON, the coordinate information generation unit 116 enters a wait state (Step S10).

When the touch panel 100 detects a touch operation on the touch panel screen 101 (YES in Step S11), the coordinate information generation unit 116 performs the following process according to whether the coordinate information generation unit 116 is in the first coordinate generation mode, the second coordinate generation mode, or the third coordinate generation mode.

In other words, the coordinate information generation unit 116 is in the first coordinate generation mode (YES in Step S12), the coordinate information generation unit 116 generates two-dimensional coordinate information of a touched position and height information of at least Z1 (Z1 is a positive value) and outputs the two-dimensional information and the height information to the processing apparatus 3 (Step S13).

Moreover, when the coordinate information generation unit 116 is in the second coordinate generation mode (YES in Step S14), the coordinate information generation unit 116 generates two-dimensional coordinate information of a touched position and height information of a zero value and then outputs the two-dimensional information and the height information to the processing apparatus 3 (Step S15).

Furthermore, when the coordinate information generation unit 116 is in the third coordinate generation mode (NO in Step S14), the coordinate information generation unit 116 generates two-dimensional coordinate information of a touched position and height information of a positive value of less than Z1 and then outputs the two-dimensional information and the height information to the processing apparatus 3 (Step S16).

Then, when the touch position is changed after the touch operation is first detected in Step S11, that is, when the planar coordinate information in the touch panel screen 101 is changed within a predetermined period of time (YES in Step S17), the coordinate information generation unit 116 enters the mouse operation mode (Step S18).

In the mouse operation mode, the coordinate information generation unit 116 generates change amount information indicating a change amount of the planar position coordinates, and outputs the information to the processing apparatus 3.

Subsequently, when the touch operation is not detected in a certain period of time (NO in Step S19), the coordinate information generation unit 116 returns to a wait state (Step S10).

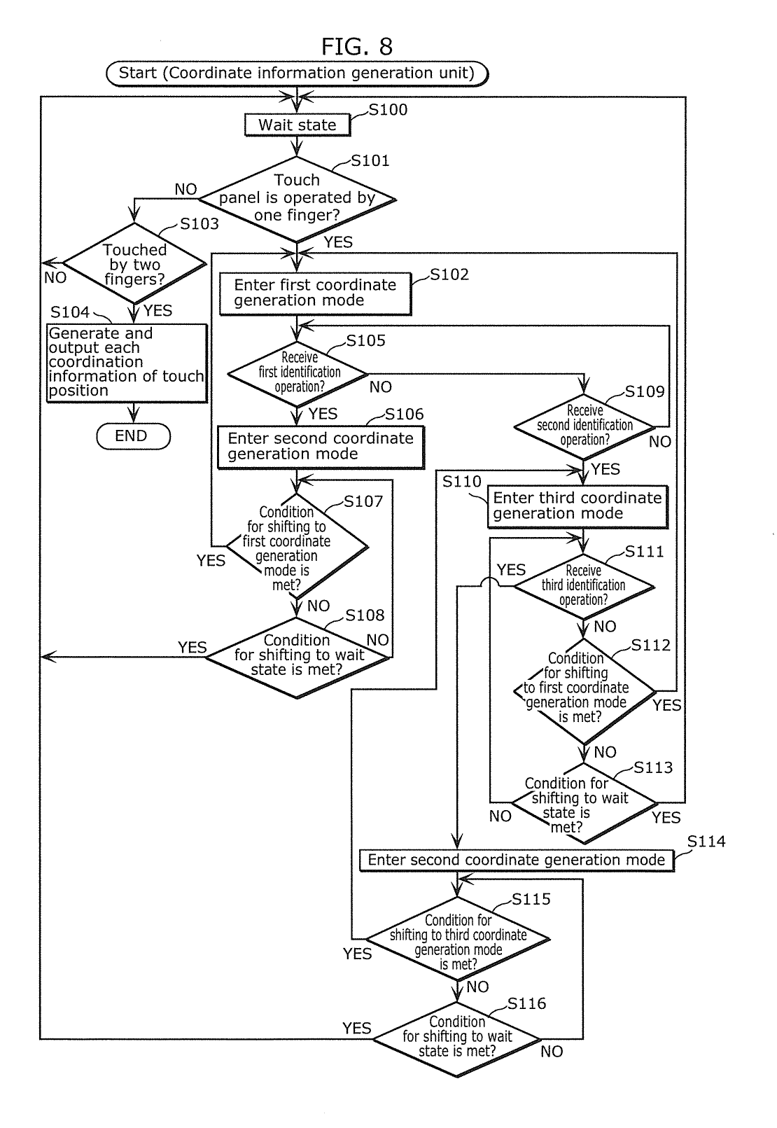

Next, a coordinate generation mode shift process by the coordinate information generation unit 116 will be described. FIG. 8 is a flowchart illustrating a coordinate generation mode shift process performed by the coordinate information generation unit 116.

When the touch panel screen 101 of the touch panel 100, in a wait state (YES in Step S100), is operated by one finger (YES in Step S101), the coordinate information generation unit 116 enters the first coordinate generation mode (Step S102). Meanwhile, the touch panel screen 101, in a wait state, is operated by two fingers (NO in Step S101, YES in Step S103), the coordinate information generation unit 116 generates the planar coordinate information each for the touched positions and then outputs the information to the processing apparatus 3 (Step S104).

Then, when the receiving unit 116B receives the first identification operation 1160A (refer to FIG. 3) (YES in Step S105), the coordinate information generation unit 116 shifts from the first coordinate generation mode to the second coordinate generation mode (Step S106).

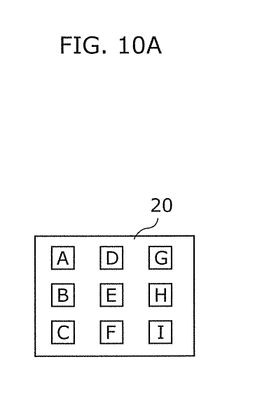

When the first identification operation 1160A is “the touch operation by another finger different from the touching finger which causes a shift to the first coordinate generation mode”, the coordinate information generation unit 116 generates planar coordinate information based on the planar coordinates indicating the touch position by another finger, and then output the information to the processing apparatus 3. At this time, the planar coordinate information indicating the touch position is converted into coordinate information in the display apparatus 2 by the processing apparatus 3, and the second cursor image CU2 (refer to (b) in FIG. 10B) is displayed on a coordinate position indicated by the converted coordinate information.

Then, when the receiving unit 116B receives the second identification operation 1160B (refer to FIG. 3) (YES in Step S109), the coordinate information generation unit 116 shifts from the first coordinate generation mode to the third coordinate generation mode (Step S110).

When the coordinate information generation unit 116 enters the second coordinate generation mode (Step S106) and then a shift condition for shifting to the first coordinate generation mode is met (YES in Step S107), the coordinate information generation unit 116 shifts from the second coordinate generation mode to the first coordinate generation mode (Step S102).

Here, “a shift condition for shifting from the second coordinate generation mode to the first coordinate generation mode” includes “the cancellation of a push operation of the first operation key 11A”, “the cancellation of the touch after the touch continues at the same position on the touch panel screen 101 for a certain period of time”, “the cancellation of the touch after a series of operations of continuing to stop the finger of the user at the same position on the touch panel screen 101, and then canceling the touch within a certain period of time, followed by touching the touch panel screen 101 again”, and “the cancellation of the touch of the finger which causes a shift to the second coordinate generation mode”.

Moreover, when in the second coordinate generation mode, a shift condition for shifting to the first coordinate generation mode is not met (NO in Step S107) and when a shift condition for shifting to the wait state is met (YES in Step S108), the coordinate information generation unit 116 returns to the wait state (Step S100).

Here, “the shift condition for shifting to a wait state” includes “the case where the touch panel screen 101 is not touched for a certain period of time” and “the cancellation of the touch of the finger which causes a shift to the second coordinate generation mode for at least a certain period of time”.

When the receiving unit 116B receives, after a shift to the third coordinate generation mode (Step S110), the third identification operation 1160C (YES in Step S111), the coordinate information generation unit 116 shifts from the third coordinate generation mode to the second coordinate generation mode (Step S114).

When the third identification operation 1160C is “the touch operation by another finger different from the touching finger which causes a shift to the third coordinate generation mode,” the coordinate information generation unit 116 generates planar coordinate information based on the planar coordinates indicating the touch position by another finger, and then outputs the information to the processing apparatus 3. At this time, the planar coordinate information indicating the touch position is converted into coordinate information in the display apparatus 2 by the processing apparatus 3, and the third cursor image CU3 (refer to (c) in FIG. 10B) is displayed at a coordinate position indicated by the converted coordinate information.

When the coordinate information generation unit 116 shifts to the third coordinate generation mode (Step S110) and then a shift condition for shifting to the first coordinate generation mode is met (YES in Step S112), the coordinate information generation unit 116 shifts from the third coordinate generation mode to the first coordinate generation mode (Step S102).

Here, “the shift condition for shifting to the third coordinate generation mode to the first coordinate generation mode” includes “the case where the touch position is changed or the touch is canceled after the touch which continues for a certain period of time at the same position of the touch panel screen 101 is detected” “the cancellation of the finger which causes a shift to the third coordinate generation mode,” and “an operation of accelerating a change of the touch position on the touch panel screen 101”.

When the coordinate information generation unit 116 shifts to the third coordinate generation mode (Step S110) and then a shift condition for shifting to the wait state is met (YES in Step S113), the coordinate information generation unit 116 returns from the third coordinate generation mode to the wait state (Step S100).

Here, “the shift condition for shifting from the third coordinate generation mode to the wait state” includes “the case where the touch is not detected for a certain period of time” and “the cancellation of the touch of the finger which causes a shift to the third coordinate generation mode for at least a certain period of time”.

When the coordinate information generation unit 116 enters the second coordinate generation mode (Step S114) and then a shift condition for shifting to the third coordinate generation mode is met (YES in Step S115), the coordinate information generation unit 116 shifts from the second coordinate generation mode to the third coordinate generation mode (Step S110).

Here, “the shift condition for shifting from the second coordinate generation mode to the third coordinate generation mode” includes “a stop of a push operation of the second operation key 11B”, “the cancellation of the touch after the touch for a certain period of time is detected at the same position of the touch panel screen 101”, and “the cancellation of the touch after an operation of touch again on the touch panel screen 101 is performed after the cancellation of the touch within a certain period of time”.

When the coordinate information generation unit 116 shifts to the second coordinate generation mode (Step S114) and then a shift condition for shifting to the wait state is met (YES in Step S113), the coordinate information generation unit 116 returns from the second coordinate generation mode to the wait state (Step S100).

Here, “the shift condition for shifting to a wait state” includes “the case where the touch panel screen 101 is not touched for a certain period of time” and “the cancellation of the touch of the finger which causes a shift to the second coordinate generation mode for at least a certain period of time”.

### <Operation of Processing Apparatus 3>

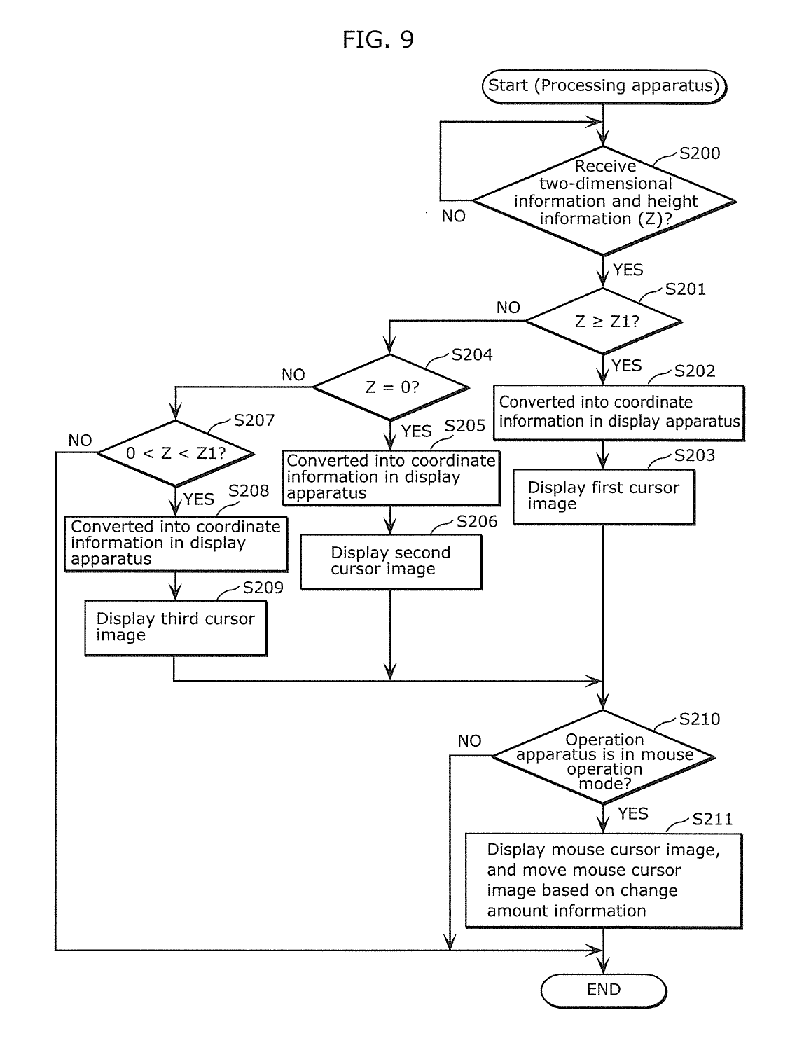

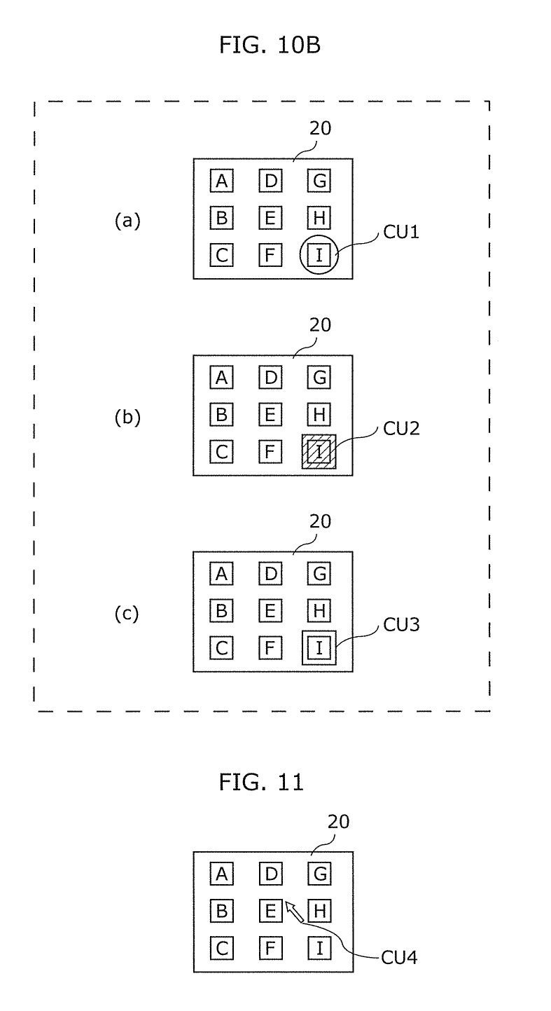

FIG. 9 is a flowchart illustrating an example of a basic operation of the processing apparatus 3. FIG. 10A is a diagram illustrating an example of an image displayed by the display apparatus 2. FIG. 10B is a diagram illustrating an example of a cursor image to be superimposed on the image displayed by the display apparatus 2. FIG. 11 is a diagram illustrating an example of a mouse cursor image. It should be noted that FIG. 10A illustrates the image on which the cursor image is not superimposed, and FIG. 10B illustrates the image on which the cursor image is superimposed.

As illustrated in the flowchart in FIG. 7, since the operation apparatus 1 outputs two-dimensional coordinate information and height information (Z) to the processing apparatus 3, the CPU 33 of the processing apparatus 3 operates as follows when receiving the two-dimensional coordinate information and height information (YES in Step S200).

In other words, when receiving height information of at least a certain value Z1 (Z1 is a positive value) (YES in Step S201), the CPU 33 converts the received two-dimensional coordinate information into coordinate information in the display apparatus 2 (Step S202), outputs the converted coordinate information and the first cursor image information to the display apparatus 2, and displays the first cursor image CU1 (refer to (a) in FIG. 10B) at a coordinate position indicated by the converted coordinate information (Step S203).

Moreover, when receiving height information of a zero value (YES in Step S204), the CPU 33 converts the received two-dimensional coordinate information into coordinate information in the display apparatus 2 (Step S205), outputs the converted coordinate information and the second cursor image information to the display apparatus 2, and displays the second cursor image CU2 (refer to (b) in FIG. 10B) at a coordinate position indicated by the converted coordinate information (Step S206).

Furthermore, when receiving height information of more than zero and less than a certain value Z1 (Z1 is a positive value) (YES in Step S207), the CPU 33 converts the received two-dimensional coordinate information into coordinate information in the display apparatus 2 (Step S208), outputs the converted coordinate information and the third cursor image information to the display apparatus 2, and displays the third cursor image CU3 (refer to (c) in FIG. 10B) at a coordinate position indicated by the converted coordinate information (Step S209).

Then, when the operation apparatus 1 shifts to the mouse operation mode (Step S210), the change amount information is outputted from the operation apparatus 1 to the processing apparatus 3. Then the processing apparatus 3 receives this change amount information, outputs the mouse cursor information to the display apparatus 2 and displays the mouse cursor image CU4 (refer to FIG. 11), and shifts the mouse cursor image CU4 on the display screen 20 based on the change amount information (Step S211).

It should be noted that the CPU 33 of the processing apparatus 3 makes a difference in the shape and the color for each of the first cursor image CU1, the second cursor image CU2, and the third cursor image CU3. The first cursor image CU1 illustrated in (a) in FIG. 10B is illustrated with a circle, the second cursor image CU2 is illustrated with a hatched square, and the third cursor image CU3 illustrated in (c) in FIG. 10B is illustrated with a blank square.

### <Advantageous Effects>

As described above, according to Embodiment 1, since (i) the two-dimensional coordinates on the plane of the touch position in the touch panel screen 101 of the touch panel 100 and (ii) height information (Z) in a perpendicular direction with respect to the touch panel screen 101 are generated according to the coordinate generation mode, the user does not have to move the finger while maintaining the finger at a certain height above the touch panel screen 101.

Therefore, the user can operate the operation apparatus 1 without paying attention to the distance between the touch panel screen 101 and the finger and without having stress. Accordingly, it is possible to provide the operation apparatus 1 with good operability.

Moreover, since the cursor images CU1 to CU3 corresponding to the coordinate generation mode of the operation apparatus 1 are displayed on the display screen 20 of the display apparatus 2, the user can tell at a glance which coordinate generation mode the operation apparatus 1 belongs to.

Moreover, when the user moves the finger on the touch panel screen 101, the mouse cursor image CU4 displayed on the display screen 20 also moves. Therefore, the operability is high since the user feels as if the operation in the touch panel screen 101 were performed on the display screen 20 of the display apparatus 2.

### Embodiment 2

Hereinafter, Embodiment 2 of the present invention will be described. It should be noted that the basic configurations of the operation apparatus 1, the display apparatus 2, and the processing apparatus 3 are the same as those described above. However, the function of the touch panel 100 (refer to FIG. 2) is different from the function of the touch panel 100 according to Embodiment 1.

In Embodiment 2, the touch panel 100 has a function of detecting the touch position of the finger in the touch panel screen 101, and a function of detecting height of the finger above the touch panel screen 101 with respect to the touch panel screen 101.

In other words, when the finger is located in a three-dimensional space within a certain range of heights above the touch panel screen 101, the touch panel 100 generates the three-dimensional information of the finger to the coordinate information generation unit 116.

Moreover, the coordinate information generation unit 116 has the first coordinate generation mode, the second coordinate generation mode, and the third coordinate generation mode, as well as a 3D operation mode, and a 2D operation mode.

Furthermore, the third operation key 11C is assigned with the function of selecting whether the coordinate information generation unit 116 is in the 3D operation mode or the 2D operation mode.

Furthermore, the CPU 33 of the processing apparatus 3 outputs, to the operation apparatus 1, any one of the 2D operation mode information 35E, the 3D operation mode information 35F, and the mouse operation mode 35G.

### <Operation of Operation Apparatus 1>

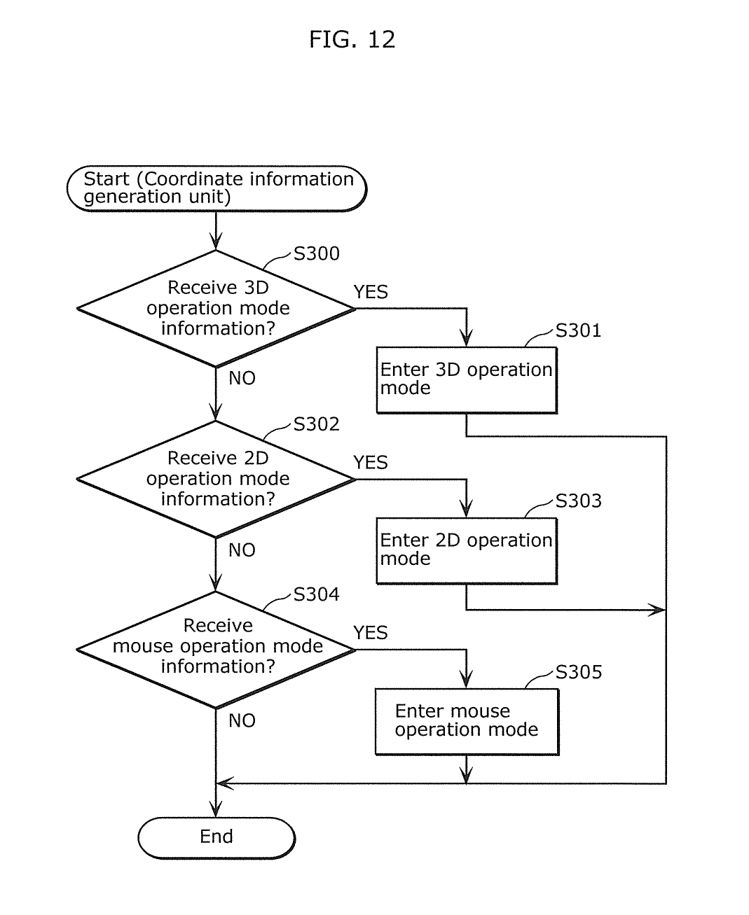

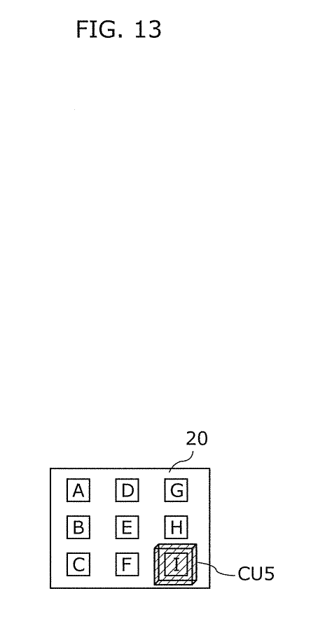

FIG. 12 is a flowchart illustrating an example of a basic operation of a coordinate information generation unit 116 of the operation apparatus 1 according to Embodiment 2 of the present invention. FIG. 13 is a diagram illustrating an example of a cursor image to be displayed in the display apparatus 2 according to Embodiment 2 of the present invention.

When receiving the 3D operation mode information 35F (refer to FIG. 4) from the processing apparatus 3 (YES in Step S300), the coordinate information generation unit 116 enters the 3D operation mode (Step S301). Here, the output of the 3D operation mode information 35F by the processing apparatus 3 includes when the third operation key 11C (refer to FIG. 2) is operated and the 3D operation mode is selected, and when the processing apparatus 3 executes the application program 350A (refer to FIG. 5).

In the 3D operation mode, the coordinate information generation unit 116 generates stereoscopic coordinate information indicating the three-dimensional position information of the finger in a three-dimensional space within a certain range of heights above the touch panel screen 101, and output the stereoscopic information to the processing apparatus 3.

Using the stereoscopic coordinate information, the processing apparatus 3 recognizes X-Y coordinate position information of the finger above the touch panel screen 101, and converts the information into coordinate information in the display apparatus 2. Moreover, using the stereoscopic coordinate position, the processing apparatus 3 recognizes height information of the finger above the touch panel screen 101.

The processing apparatus 3 outputs, along with the cursor image corresponding to height information, the converted coordinate information to the display apparatus 2. With this, the display apparatus 2 displays the cursor image corresponding to the height information at a coordinate position corresponding to the touch position in the touch panel screen 101.

It should be noted that it is desirable that the cursor image CU5 displayed in the 3D operation mode, as illustrated in FIG. 13, has a color and a shape that are different from those of the cursor images CU1 to CU3 in the 2D operation mode.

When receiving the 2D operation mode information 35E (refer to FIG. 4) from the processing apparatus 3, the coordinate information generation unit 116 enters the 2D operation mode (Step S303). Here, the output of the 2D operation mode information 35E by the operation apparatus 3 includes when the third operation key 11C (refer to FIG. 2) is operated and the 2D operation mode is selected, and when the processing apparatus 3 executes the application program 350B (refer to FIG. 5).

When entering the 2D operation mode, the coordinate information generation unit 116 performs the same process as that of Embodiment 1 using the planar coordinate information indicating the coordinate position of the finger in the touch panel screen 101 of the touch panel 100, without using the three-dimensional position information of the finger outputted from the touch panel 100.

When receiving the mouse operation mode information 35G (refer to FIG. 4) from the processing apparatus 3 (YES in Step S304), the coordinate information generation unit 116 enters the mouse operation mode (Step S305).

### <Advantageous Effects>

As described above, according to Embodiment 2, even when the touch panel 100 which can detect the three-dimensional position information is used, the coordinate information generation unit 116 performs the same process as that of Embodiment 1 in the 2D operation mode.

Therefore, even when the touch panel 100 which can detect the three-dimensional position information is used, it is possible to generate the same advantageous effects as those of Embodiment 1.

### Embodiment 3

### <Configuration of Information Processing System>

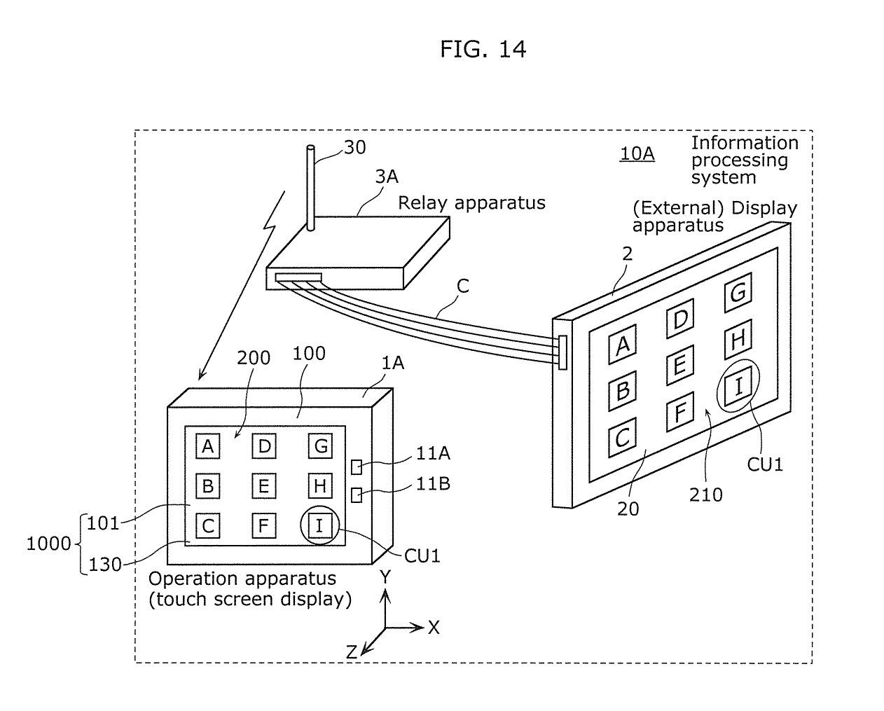

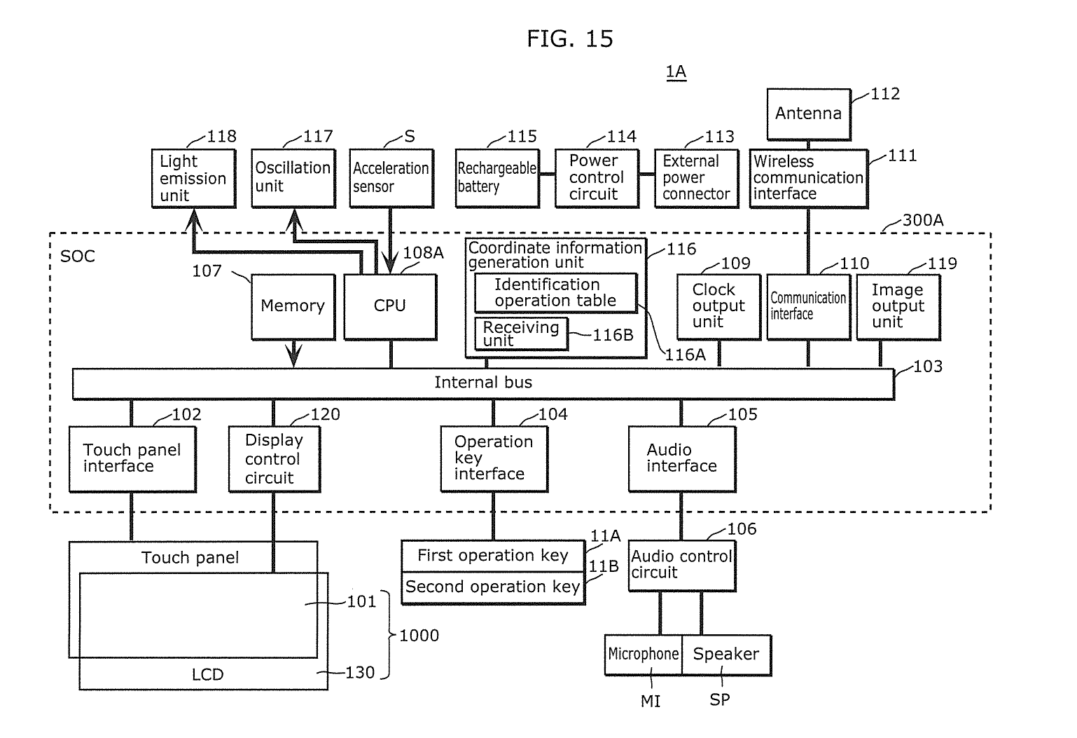

FIG. 14 is a system configuration diagram illustrating an example of an information processing system according to Embodiment 3 of the present invention. FIG. 15 is a block diagram illustrating an example of functional blocks of an operation apparatus according to Embodiment 3 of the present invention. It should be noted that in the present embodiment, the same reference signs are assigned to the same structural elements as those of Embodiment 1, and a description thereof will be omitted.

An information processing system 10A illustrated in FIG. 14 includes an operation apparatus 1A, a display apparatus 2, and a relay apparatus 3A.

This information processing system 10A is a system which transmits, via the relay apparatus 3A to the display apparatus 2, the image on which the cursor image CU1 is superimposed in an image 200 displayed in the operation apparatus 1A, and then displays it as an image 210 on the display screen 20 of the display apparatus 2.

Moreover, the information processing system 10A is a system which when the operation apparatus 1A is in the mouse operation mode to be described later, the user uses the touch panel 100 of the operation apparatus 1A as if the touch panel 100 were a mouse and reflects the operation of touch, drag and drop, double click on the touch panel screen 101 on the display screen 20 of the display apparatus 2.

In other words, this information processing system 10A is a system which provides the display screen 20 of the display apparatus 2 to the user as a virtual touch panel and a virtual mouse.

The operation apparatus 1A includes a touch screen display 1000 on which a liquid crystal display (LCD) 130 (a display unit) is disposed behind the transparent touch panel screen 101.

This touch screen display 1000 has a function of detecting a touch operation by the user and also functions as a touch pad which realizes a mouse operation equivalent function. The touch screen display 1000 receives, as a function of the mouse operation equivalent function, the operations usually performed with the mouse, such as the user's drag and drop, and double click.

The operation apparatus 1A includes not only the touch screen display 1000 but also a first operation key 11A and a second operation key 11B to be described later.

The relay apparatus 3A is wirelessly connected to the operation apparatus 1A, and is connected to the display apparatus 2 via a cable C. The relay apparatus 3A relays the image information transmitted from the operation apparatus 1A to the display apparatus 2.

It should be noted that the relay apparatus 3A and the display apparatus 2 may be able to perform wireless communication between them. Moreover, although in Embodiment 3, the operation apparatus 1A and the relay apparatus 3A are separately provided, the present embodiment is not limited to this example. It is possible that the present embodiment is a single apparatus which includes the functions of the operation apparatus 1A and the relay apparatus 3A.

### <Configuration of Operation Apparatus 1A>

As illustrated in FIG. 15, the SOC 300A of the operation apparatus 1A includes not only the constituent elements described in Embodiment 1 but also an image output unit 119 and a display control circuit 120.

The image output unit 119 is a unit which outputs, via the communication interface 110 to the relay apparatus 3A, the image information stored in the memory 107, that is, the image information indicating the image 200 displayed on the liquid crystal display 130. The image output unit 119 is connected to the wireless communication interface 111 via the internal bus 103. With this, the image output unit 119 is wirelessly connected to the relay apparatus 3A. Since the relay apparatus 3A is wired connected to the display apparatus 2, the image output unit 119 is connected to the display apparatus 2 via the relay apparatus 3A.

The display control circuit 120 is a circuit which controls to display the image 200 on the liquid crystal display 130. The display control circuit 120 displays the image 200 on the liquid crystal display 130 by controlling the orientations of liquid crystal molecules based on the image information indicating the image.

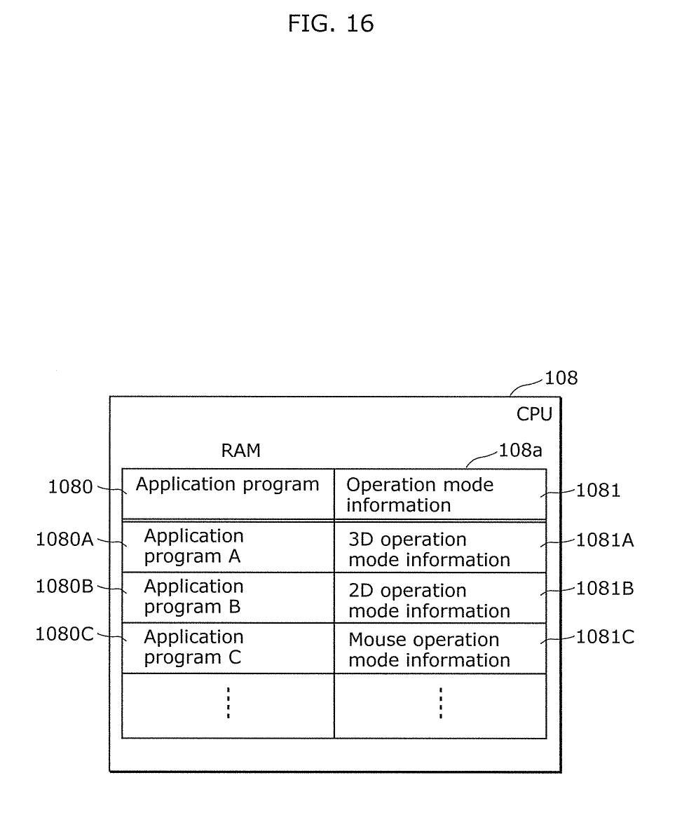

Furthermore, the CPU 108A has an operation mode table 108a. This operation mode table 108a is stored in a random access memory (RAM) comprising the CPU 108A. FIG. 16 is a diagram illustrating an example of a configuration of the operation mode table 108a.

The operation mode table 108a stores an application program executed by the CPU 108A, and operation mode information 1081 corresponding to the application program 1080. In an example illustrated in FIG. 16, 3D operation mode information 1081A is stored corresponding to an application program 1080A. Moreover, 2D operation mode information 1081B is stored corresponding to an application program 1080B. Furthermore, mouse operation mode information 1081C is stored corresponding to an application program 1080C.

It should be noted that the description of the 3D operation mode information 1081A, the 2D operation mode information 1081B, and the mouse operation mode information 1081C will be omitted since they are the same as those in Embodiment 1.

### <Configuration of Relay Apparatus 3A>

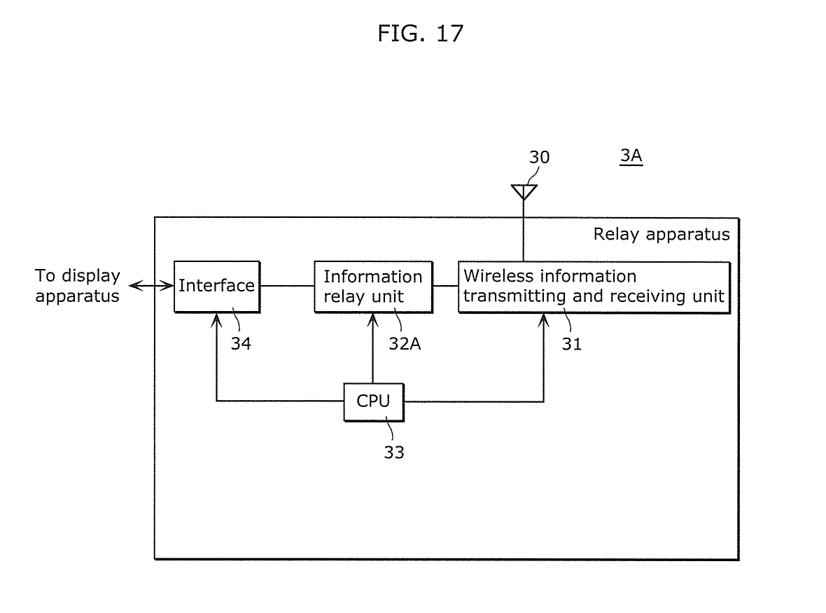

The display apparatus 2 displays an image provided by the processing apparatus 1A. Therefore, the relay apparatus 3A is a relay apparatus which receives the image from the operation apparatus 1A, and then relays the image to the display apparatus 2. FIG. 17 is a block diagram illustrating an example of the functional configuration of the relay apparatus 3A.

The relay apparatus 3A includes a wireless information transmitting and receiving unit 31, an information relay unit 32A, a CPU 33, and an interface 34.

The information relay unit 32A is a unit which relays various information items received from the operation apparatus 1A to the display apparatus 2. It should be noted that the description of the wireless information transmitting and receiving unit 31, the CPU 33, and the interface 34 will be omitted since they are the same as those in Embodiment 1.

### <Operation of Coordinate Information Generation Unit 116>

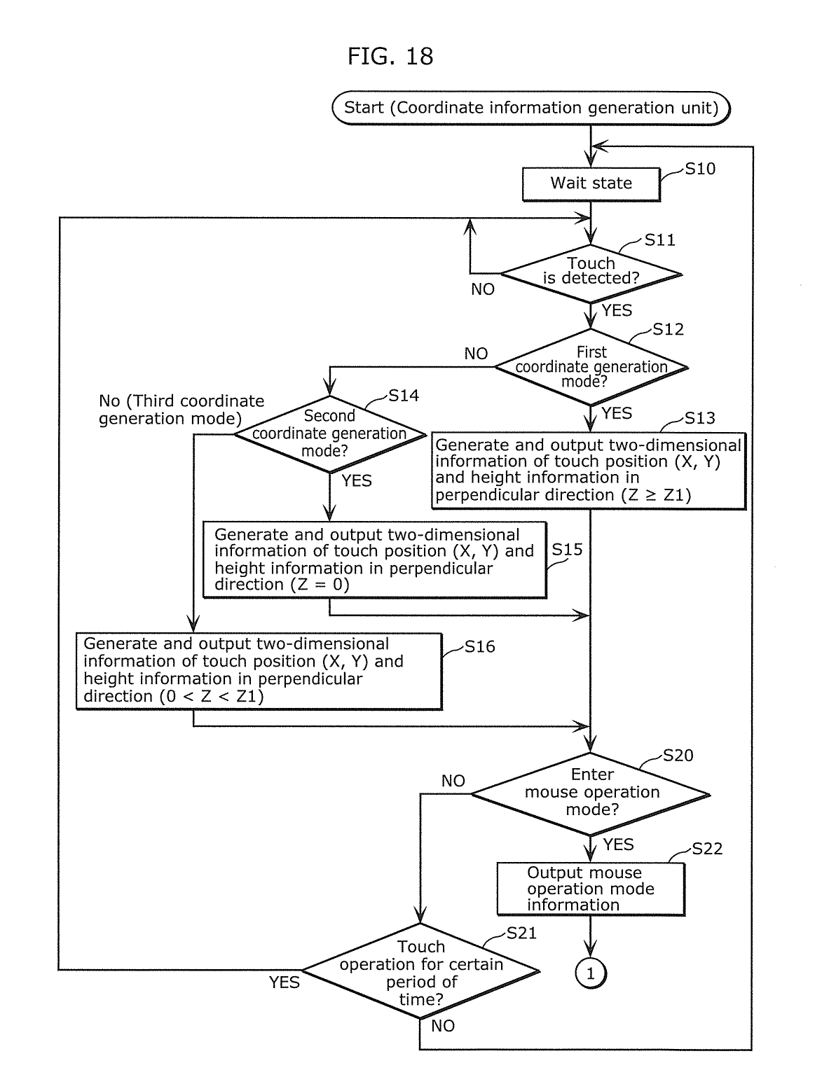

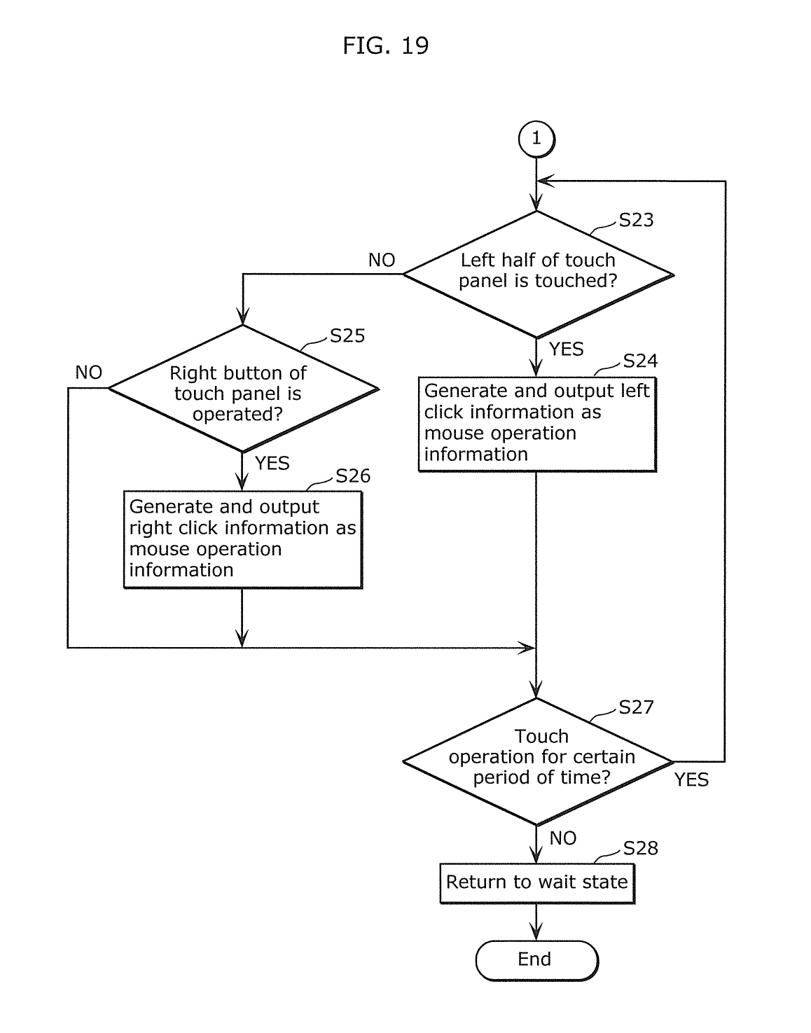

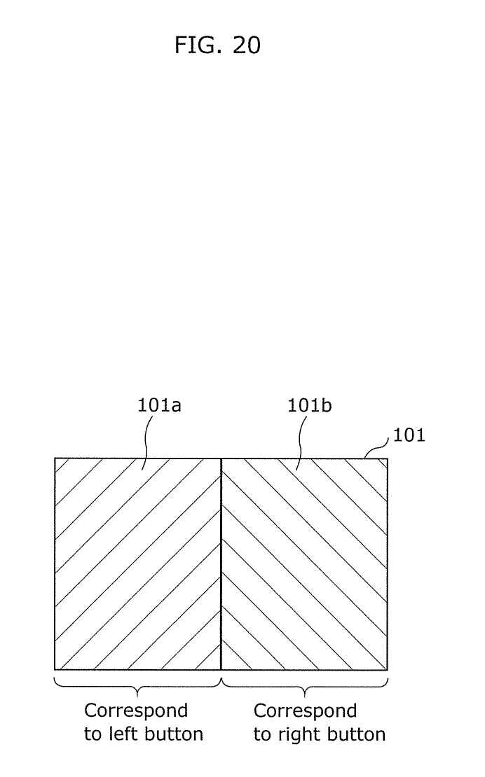

FIGS. 18 and 19 are each a flowchart illustrating an example of a basic operation of the coordinate information generation unit 116 of the operation apparatus 1A. FIG. 20 is a diagram illustrating an example of the functional configuration of the touch panel 100 when the coordinate information generation unit 116 is in a mouse operation mode.

First, as similarly to Embodiment 1, Step S10 to Step S16 are performed. It should be noted that in Step S13, Step S15, and Step S16, the coordinate information generation unit 116 outputs, to the CPU 108A, the generated two-dimensional coordinate information and height information.

Subsequently, when shifting to the mouse operation mode (YES in Step S20), the coordinate information generation unit 116 perform the following processes after outputting the mouse operation mode information to the CPU 108A (Step S22). It should be noted that the shift of the coordinate information generation unit 116 to the mouse operation mode includes a change of the touch position by drag in the touch panel screen 101 within a certain period of time.

In the mouse operation mode, the coordinate information generation unit 116 handles, as an operation of the left button of the mouse, an operation in the left half area 101a of the touch panel screen 101 (refer to FIG. 20). Specifically, when the left half area 101a of the touch panel screen 101 is touched (YES in Step S23), the coordinate information generation unit 116 generates left click information indicating that the left button of the mouse is clicked, and then outputs the left click information as the mouse operation information to the CPU 108A (Step S24).

Meanwhile, the coordinate information generation unit 116 handles, as an operation of the right button of the mouse, an operation in the right half area 101b of the touch panel screen 101 (refer to FIG. 2). Specifically, when the right half area 101b of the touch panel screen 101 is touched (NO in Step S23, YES in Step S25), the coordinate information generation unit 116 generates right click information indicating that the right button of the mouse is clicked, and then outputs the right click information as the mouse operation information to the CPU 108A (Step S26).

Subsequently, when the touch operation on the touch panel screen 101 is not detected for a certain period of time (NO in Step S27), the coordinate information generation unit 116 returns to a wait state (Step S28).

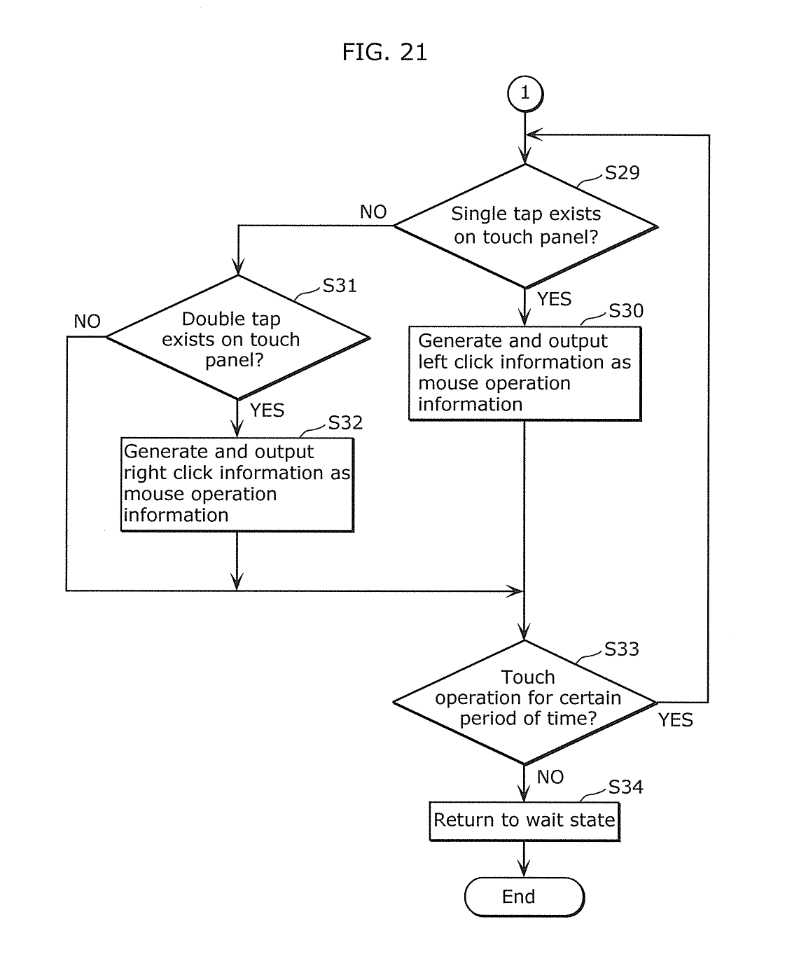

FIG. 21 is a flowchart illustrating another example of a basic operation when the coordinate information generation unit 116 is in a mouse operation mode. When a single tap exists as an identification operation in the touch panel screen 101 (YES in Step S29), the coordinate information generation unit 116 generates left click information indicating that a left click is performed, and then outputs the left click information to the CPU 108A (Step S30).

When a double tap exists as an identification operation in the touch panel screen 101 (NO in Step S29, YES in Step S31), the coordinate information generation unit 116 generates right click information indicating that a right click is performed, and then outputs the right click information to the CPU 108A (Step S32).

Subsequently, when the touch operation on the touch panel screen 101 is not detected in a certain period of time (NO in Step S33), the coordinate information generation unit 116 returns to a wait state (Step S34).

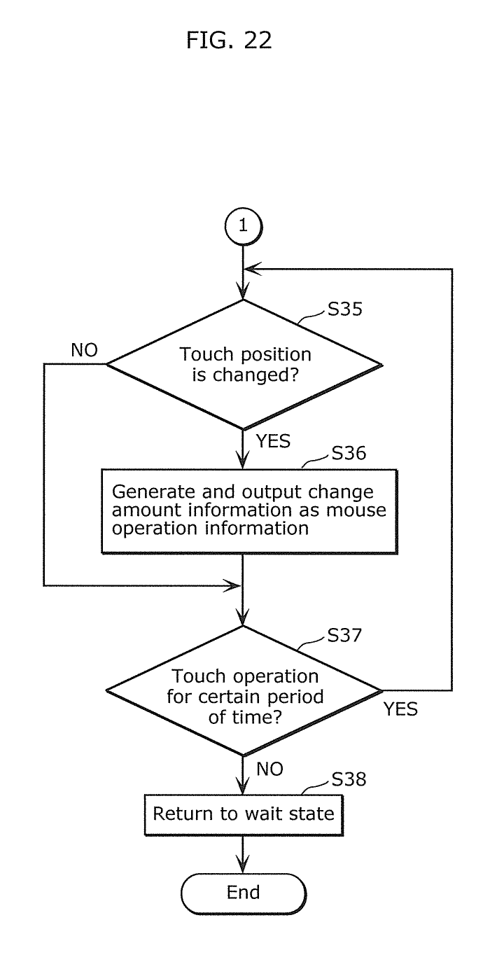

FIG. 22 is a flowchart illustrating a still another example of a basic operation when the coordinate information generation unit 116 is in a mouse operation mode. When the touch position in the touch panel screen 101 is changed (YES in Step S35), the coordinate information generation unit 116 outputs change amount information indicating the change amount as mouse operation information to the CPU 108A (Step S36).

Subsequently, when the touch operation on the touch panel screen 101 is not detected for a certain period of time (NO in Step S37), the coordinate information generation unit 116 returns to a wait state (Step S38).

It should be noted that the description of a coordinate generation mode shift process by the coordinate information generation unit 116 will be omitted because the process is the same as that in above described Embodiment 1.

### <Operation of CPU 108>

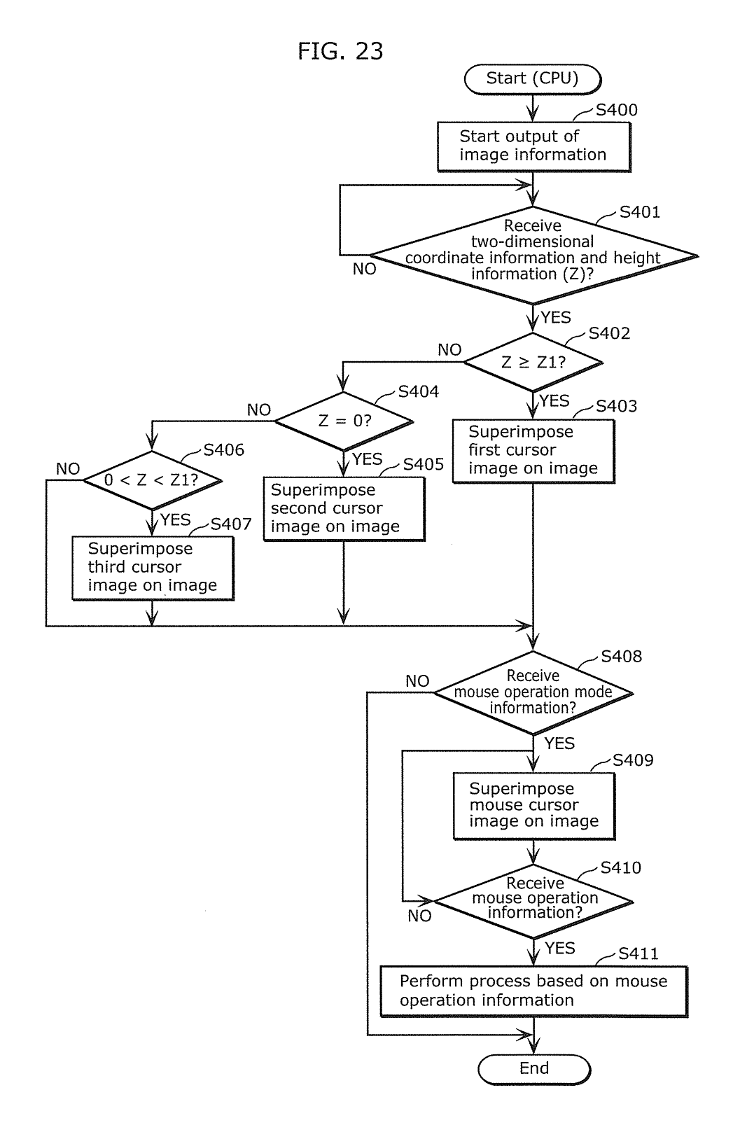

FIG. 23 is a flowchart illustrating an example of a basic operation of the CPU 108A. First, the CPU 108A starts an output of the image information indicating the image (for example, the image illustrated in FIG. 10A) which is previously stored in the memory 107 and is displayed on the liquid crystal display 130 of the operation apparatus 1A (Step S400).

Then, since as illustrated in the flowchart in FIG. 18, the coordinate information generation unit 116 outputs the two-dimensional information and height information (Z) to the CPU 108A, the CPU 108A, on receipt of these information items (YES in Step S401), operates as follows.

In other words, when receiving height information of a certain value of at least Z1 (Z1 is a positive value) (YES in Step S402), the CPU 108A outputs, via the relay apparatus 3A to the display apparatus 2, the image obtained by superimposing the first cursor image CU1 on the output image at a coordinate position indicated by the received two-dimensional coordinate information (Step S403). At this time, in the display screen 20 of the display apparatus 2, as illustrated in (a) in FIG. 10B, the image on which the first cursor image CU1 is superimposed is displayed.

In other words, when receiving height information of a zero value (YES in Step S404), the CPU 108A outputs, via the relay apparatus 3A to the display apparatus 2, the image obtained by superimposing the second cursor image CU2 on the output image at a coordinate position indicated by the received two-dimensional coordinate information (Step S405). At this time, in the display screen 20 of the display apparatus 2, as illustrated in (b) in FIG. 10B, the image on which the second cursor image CU2 is superimposed is displayed.

Furthermore, when receiving height information of more than zero and less than a certain value Z1 (Z1 is a positive value) (YES in Step S406), the CPU 108A outputs, via the relay apparatus 3A to the display apparatus 2, the image obtained by superimposing the third cursor image CU3 on the output image at a coordinate position indicated by the received two-dimensional coordinate information (Step S407). At this time, in the display screen 20 of the display apparatus 2, as illustrated in (c) in FIG. 10B, the image on which the third cursor image CU3 is superimposed is displayed.

Then, when receiving the mouse operation mode information from the coordinate information generation unit 116 (YES in Step S408), the CPU 108A outputs, to the display apparatus 2 via the relay apparatus 3A, the image obtained by superimposing the mouse cursor image CU4 (refer to FIG. 11) on the output image (Step S409).

Then, when receiving the mouse operation information from the coordinate information generation unit 116 (YES in Step S410), the CPU 108A performs a process based on the mouse operation information (Step S411).

For example, when as the process based on the mouse operation information, the left click information is outputted from the coordinate information generation unit 116, the CPU 108A performs a predetermined process by determining that the left click is performed. Meanwhile, when the right click information is outputted from the coordinate information generation unit 116, the CPU 108A performs a predetermined process by determining that the right click is performed.

Moreover, when receiving, from the coordinate information generation unit 116 as the mouse operation information, the change amount information indicating the change amount of the touch position in the touch panel screen 101, the CPU 108A superimposes, on the output image, the mouse cursor image CU4 whose coordinate position is shifted by the change amount indicated by the information.

It should be noted that as similarly to Embodiment 1, as illustrated in FIG. 10, the CPU 108A makes a difference in the shape and the color for each of the first cursor image CU1, the second cursor image CU2, and the third cursor image CU3.

### <Advantageous Effects>

As described above, in Embodiment 3, when the touch operation is performed on the touch panel screen 101, in synchronization with this touch operation, the first cursor image CU1 to the third cursor image CU3 are superimposed on the image in the display apparatus 2.

Therefore, the user feels as if the liquid crystal display 130 in the operation apparatus 1A existed in the display apparatus 2. Moreover, the user feels as if the touch panel screen 101 in the operation apparatus 1A existed in the display apparatus 2.

Accordingly, the user can, without looking at the operation apparatus 1A, display the first cursor image CU1 to the third cursor image CU3 in the image of the display apparatus 2 while watching the display screen 20 of the display apparatus 2. With this, it is possible to provide the operation apparatus 1A that is user-friendly.

Moreover, with this configuration, the mouse operation equivalent function of the touch panel screen 101 is realized by integrating with the liquid crystal display 130. Therefore, when the touch position is moved in the touch panel screen 101 of the operation apparatus 1A, the mouse cursor image CU4 in the display apparatus 2 moves in synchronization with this.

Therefore, the user feels as if the moving operation of the touch position in the touch panel screen 101 were performed on the display screen 20 of the display apparatus 2.

Accordingly, since the mouse cursor image CU4 can be moved without stress, it is possible to provide the operation apparatus 1A that is user-friendly.

### Embodiment 4

In Embodiment 4, the touch panel 100 according to Embodiment 3, as similarly to that according to Embodiment 2, has a function of detecting the touch position of the finger in the touch panel screen 101, and a function of detecting height of the finger above the touch panel screen 101.

In this case, the CPU 108A outputs, to the coordinate information generation unit 116, any one of the 3D operation mode information 1081A, the 2D operation mode information 1081B, and the mouse operation information 1081C.

When receiving the 3D operation mode information 1081A (refer to FIG. 16) from the CPU 108A, the coordinate information generation unit 116 enters the 3D operation mode. Here, the output by the CPU 108A of the 3D operation mode information 1081A includes when the CPU 108A executes the application program 1080A (refer to FIG. 16).

In the 3D operation mode, the coordinate information generation unit 116 generates stereoscopic coordinate information indicating the three-dimensional position information of the finger in the three-dimensional space within a certain range of heights above the touch panel screen 101, and outputs the stereoscopic coordinate information to the CPU 108A. The CPU 108A recognizes X-Y coordinate position information of the finger above the touch panel screen 101, and determines coordinate determines a coordinate position indicated by the coordinate position information. Moreover, the CPU 108A recognizes, using the stereoscopic coordinate position, height information of the finger above the touch panel screen 101.

The CPU 108A superimposes, in the image outputted by the image output unit 119, the cursor image corresponding to height information at the determined coordinate position.

When receiving the 2D operation mode information 1081B (refer to FIG. 16) from the CPU 108A, the coordinate information generation unit 116 enters the 2D operation mode. Here, the output by the CPU 108A of the 2D operation mode information 1081B includes when the CPU 108A executes the application program 1080B (refer to FIG. 16).

When entering the 2D operation mode, the coordinate information generation unit 116 performs the same process as that of Embodiment 1 not by using the three-dimensional position information of the finger outputted from the touch panel screen 101 but by using the planar coordinate information indicating the coordinate position of the finger in the touch panel screen 101.

When receiving the mouse operation mode information 1081C (refer to FIG. 16) from the CPU 108A, the coordinate information generation unit 116 enters the mouse operation mode. Here, the output by the CPU 108A of the mouse operation mode information 1081C includes when the CPU 108A executes the application program 1080C (refer to FIG. 16).

When entering the mouse operation mode, the coordinate information generation unit 116 performs the same process as that of Embodiment 3.

### Other Embodiments

In Embodiment 2, the processing apparatus 3 may, according to the execution state of any one of the application programs 350A to 350C, output any one of the 3D operation mode information 351A, the 2D operation mode information 351B, and the mouse operation information 351C to the operation apparatus 1.

Moreover, in Embodiments 2 and 4, the coordinate information generation unit 116 may enter any one of the 3D operation mode, the 2D operation mode, and the mouse operation mode, based on orientation information outputted from the acceleration sensor S. It should be noted that the orientation detected by the acceleration sensor S includes a holding orientation, a standstill orientation, a holding orientation in a horizontal direction, and a holding orientation in a perpendicular direction.

Moreover, the operation apparatus 1 (1A) may, at a predetermined timing, operate the oscillation unit 117 (refer to FIGS. 2 and 15) and the light emission unit 118 (refer to FIGS. 2 and 15) It should be noted that the operation timing includes a timing of shifting to the second coordinate generation mode, a timing in the second coordinate generation mode, a timing of the touch on the touch panel screen 101 in the 3D operation mode, a timing of the touch on the touch panel screen 101 in the mouse operation mode, a timing when the operation mode is switched, and a timing when communication between the operation apparatus 1 (1A) and the processing apparatus 3 (the relay apparatus 3A) is established.

Although in Embodiments 3 and 4, the CPU 108A is provided in the operation apparatus 1A, the present invention is not limited to this example. It is possible that the CPU 108A may be provided in the relay apparatus 3A or the display apparatus 2. In this case, when receiving various information items from the coordinate information generation unit 116 of the operation apparatus 1A, the relay apparatus 3A or the display apparatus 2 superimposes, based on the information items, the cursor image on the image displayed on the display apparatus 2.

Although the information processing system and the operation apparatus according to embodiments of the present invention have been described, the present invention is not limited only to the embodiments.

For example, each of the aforementioned described apparatuses may be configured as a computer system which includes a microprocessor, a ROM, a RAM, a hark disk drive, a display unit, a keyboard, and a mouse. A computer program is stored in the RAM or hard disk drive. The respective apparatuses achieve their functions through the microprocessor's operation according to the computer program. Here, the computer program is configured by combining plural instruction codes indicating the instructions to the computer in order to achieve the predetermined function.

Furthermore, a part or all of the constituent elements constituting the respective apparatuses may be configured from single System Large Scale Integration (LSI). The System-LSI is a super-multi-functional LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

A part of all of the constituent elements constituting the respective apparatuses may be configured as an IC card which can be attached or detached from the respective apparatuses or as a stand-alone module. The IC card of the module is a computer system configured from a microprocessor, a ROM, a RAM, and so on. The IC card or the module may be included in the aforementioned super-multi-functional LSI. The IC card or the module achieves its function through the microprocessor's operation according to the computer program. The IC card or the module may also be implemented to be tamper-resistant.

The present invention may be a method described above. Moreover, the present invention may be a computer program for realizing the previously illustrated method, using a computer, and may also be a digital signal including the computer program. Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc, registered trademark), and a semiconductor memory. Furthermore, the present invention also includes the digital signal recorded these recording media.

Furthermore, the present invention may also be realized by the transmission of the aforementioned computer program or digital signal via a telecommunication line, a wired or wireless communication network, a network represented by the Internet, a data broadcast, and so on.

The present invention may also be a computer system including a microprocessor and a memory, in which the memory stores the aforementioned computer program and the microprocessor operates according to the computer program.

Furthermore, by transferring the program or the digital signal by recording onto the aforementioned recording media, or by transferring the program or the digital signal via the aforementioned network and the like, execution using another independent computer system is also made possible.

Furthermore, it is possible to combine each of the above described embodiments with each of the modifications.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present invention is applicable to, for example, a smartphone and an information processing system which includes a processing apparatus performing the process based on a platform with the smartphone.

1. An operation apparatus comprising:
a touch panel which has a touch panel screen and detects a coordinate position on a plane touched on the touch panel screen;
a coordinate information generation unit configured to generate coordinate information indicating the coordinate position at which the touch was made and has a plurality of coordinate generation modes to use planar coordinate information indicating a coordinate position of a finger of a user on the touch panel screen, the coordinate generation modes including a first coordinate generation mode;
a receiving unit configured to receive an identification operation for switching, among the coordinate generation modes, from one of the coordinate generation modes to another; and
an output unit configured to output the coordinate information generated by the coordinate information generation unit,
wherein the coordinate information generation unit is configured to generate, according to each of the coordinate generation modes, two-dimensional coordinates of a touch position on a plane on the touch panel screen, and height information (Z) in a perpendicular direction with respect to the touch panel screen.

2. An operation apparatus comprising:
a touch panel which has a touch panel screen, and has a function of detecting a touch position of a finger of a user on the touch panel screen and a function of detecting height of the finger above the touch panel screen with respect to the touch panel screen;
a coordinate information generation unit having (i) a 3D operation mode to generate, as three-dimensional coordinate information, three-dimensional position information of the finger above the touch panel screen, and (ii) a 2D operation mode which includes a plurality of coordinate generation modes to use planar coordinate information indicating a coordinate position of the finger on the touch panel screen without using the three-dimensional position information detected when the finger is above the touch panel screen, the coordinate generation modes including a first coordinate generation mode;
an output unit configured to output the coordinate information generated by the coordinate information generation unit; and
a receiving unit configured to receive, in the 2D operation mode, an identification operation for switching from one of the coordinate generation modes to another,
wherein the coordinate information generation unit is configured to:
(i) generate, in the 3D operation mode, a detection position of the finger as three-dimensional coordinates when the finger is in a three-dimensional space within a certain range of heights above the touch panel screen, including a case where the finger touches the touch panel screen; and
(ii) generate, in the 2D operation mode, according to each of the coordinate generation modes, two-dimensional coordinates on a plane of a position touched on the touch panel screen, and height information (Z) in a perpendicular direction with respect to the touch panel screen.

3. The operation apparatus according to claim 1,
wherein the coordinate information generation unit has at least the first coordinate generation mode and a second coordinate generation mode,
the receiving unit is configured to receive a first identification operation for switching from the first coordinate generation mode to the second coordinate generation mode, and
the coordinate information generation unit is configured to:
provide a positive value in the first coordinate generation mode as the height information (Z); and
provide a zero value in the second coordinate generation mode as the height information (Z).

4. The operation apparatus according to claim 1,
wherein the coordinate information generation unit has at least the first coordinate generation mode, a second coordinate generation mode, and a third coordinate generation mode,
the receiving unit is configured to receive a second identification operation for switching from the first coordinate generation mode to the third coordinate generation mode, and a third identification operation for switching from the third coordinate generation mode to the second coordinate generation mode, and
the coordinate information generation unit is configured to:
provide a positive value of at least a certain value in the first coordinate generation mode as the height information (Z);
provide a zero value in the second coordinate generation mode as the height information (Z); and
provide a positive value of less than the certain value in the third coordinate generation mode as the height information (Z).

5. The operation apparatus according to claim 1,
wherein the coordinate information generation unit is configured to, when planar position coordinates of the touch position of the finger with respect to the touch panel are changed within a predetermined set time, shift to a mouse operation mode to generate change amount information indicating a change amount of the planar position coordinates.

6. The operation apparatus according to claim 1,
wherein the coordinate information generation unit is configured to:
be in a wait state that is not any of the coordinate generation modes, at least after a start of the operation apparatus; and
shift from the wait state to the first coordinate generation mode when, in the wait state, it is detected that the touch panel screen is touched by at least one of a plurality of the fingers.

7. The operation apparatus according to claim 4,
wherein the coordinate information generation unit is configured to enter a wait state when a touch on the touch panel screen is not detected for a certain period of time in one of the first coordinate generation mode, the second coordinate generation mode, and the third coordinate generation mode.

8. The operation apparatus according to claim 3, further comprising
a first operation key capable of shifting the coordinate information generation unit from the first coordinate generation mode to the second coordinate generation mode,
wherein the coordinate information generation unit is configured to shift from the first coordinate generation mode to the second coordinate generation mode when the receiving unit receives an operation of the first operation key as the first identification operation, and shift from the second coordinate generation mode to the first coordinate generation mode when the receiving unit no longer receives the operation of the first operation key.

9. The operation apparatus according to claim 3,
wherein the coordinate information generation unit is configured to shift from the first coordinate generation mode to the second coordinate generation mode when in the first coordinate generation mode, as the first identification operation, the touch panel detects a touch for a certain period of time at a same position on the touch panel screen, and to shift from the second coordinate generation mode to the first coordinate generation mode when the touch is canceled.

10. The operation apparatus according to claim 3,
wherein the first identification operation is a series of operations of continuing to stop the finger of the user at a same position on the touch panel screen, and then cancelling the touch within a certain period of time, followed by touching the touch panel screen, and
the coordinate information generation unit is configured to shift from the first coordinate generation mode to the second coordinate generation mode when the receiving unit receives the first identification operation in the first coordinate generation mode, and shift from the second coordinate generation mode to the first coordinate generation mode when the touch is canceled.

11. The operation apparatus according to claim 3,
wherein the first identification operation is a touch operation on the touch panel screen by another finger different from a touching finger which causes a shift to the first coordinate generation mode, and
the coordinate information generation unit is configured to:
generate the planar coordinate information based on planar coordinates which indicates a touch position of the touching finger which causes a shift to the second coordinate generation mode;
shift from the second coordinate generation mode to the first coordinate generation mode by canceling the touch of the touching finger which causes a shift to the second coordinate generation mode; and
shift from the second coordinate generation mode to a wait state by canceling, for at least a certain period of time, the touch of the touching finger which causes a shift to the second coordinate generation mode.

12. The operation apparatus according to claim 4,
wherein the coordinate information generation unit is configured to:
shift from the first coordinate generation mode to the third coordinate generation mode when in the first coordinate generation mode, as the second identification operation, the touch panel detects a touch for a certain period of time at a same position on the touch panel screen; and
shift from the third coordinate generation mode to the first coordinate generation mode when the touch position is changed or when the touch is canceled.

13. The operation apparatus according to claim 4,
wherein the coordinate information generation unit is configured to shift from the first coordinate generation mode to the third coordinate generation mode when in the first coordinate generation mode, as the second identification operation, a change of the touch position on the touch panel screen is slowed, and to shift from the third coordinate generation mode to the first coordinate generation mode when a change of the touch position on the touch panel screen is accelerated.

14. The operation apparatus according to claim 4, further comprising
a second operation key capable of shifting the coordinate information generation unit from the third coordinate generation mode to the second coordinate generation mode,
wherein the coordinate information generation unit is configured to shift from the third coordinate generation mode to the second coordinate generation mode when the receiving unit receives an operation of the second operation key as the third identification operation, and to shift from the second coordinate generation mode to the third coordinate generation mode when the receiving unit no longer receives the operation of the second operation key later.

15. The operation apparatus according to claim 4,
wherein the coordinate information generation unit is configured to shift from the third coordinate generation mode to the second coordinate generation mode when in the third coordinate generation mode, as the third identification operation, the touch panel detects a touch for a certain period of time at a same position on the touch panel screen, and shift from the second coordinate generation mode to the third coordinate generation mode when the touch is canceled later.

16. The operation apparatus according to claim 4,
wherein the third identification operation is a series of operations of canceling the touch within a certain period of time, and then touching the touch panel screen again, and
the coordinate information generation unit is configured to shift from the third coordinate generation mode to the second coordinate generation mode when the receiving unit receives the third identification operation in the third coordinate generation mode, and then shift from the second coordinate generation mode to the third coordinate generation mode when the touch is canceled later.

17. The operation apparatus according to claim 4,
wherein the third identification operation is a touch operation on the touch panel screen by another finger different from a touching finger which causes a shift to the first coordinate generation mode and the third coordinate generation mode, and
the coordinate information generation unit is configured to:
generate the planar coordinate information based on planar coordinates which indicates a touch position of the touching finger which causes a shift to the third coordinate generation mode;
shift from the third coordinate generation mode to the first coordinate generation mode by canceling the touch of the touching finger which causes a shift to the third coordinate generation mode; and
shift from the third coordinate generation mode to a wait state by canceling, for at least a certain period of time, the touch of the touching finger which causes a shift to the third coordinate generation mode.

18. The operation apparatus according to claim 1, further comprising:
a display unit;
an image output unit configured to output an image displayed on the display unit to an external display apparatus; and
a central processing unit (CPU) configured to, when outputting the image by connecting the external display apparatus to the image output unit, superimpose, on the image, a cursor image corresponding to the coordinate generation mode in synchronization with a touch operation on the touch panel screen, and output the image on which the cursor image is superimposed to the external display apparatus,
wherein the touch panel screen is transparent, and functions as a touch screen display by integrating with the display unit.

19. The operation apparatus according to claim 1, further comprising:
a display unit;
an image output unit configured to output an image displayed on the display unit to an external display apparatus;
a central processing unit (CPU) configured to, when outputting the image by connecting the external display apparatus to the image output unit, superimpose, on the image, a mouse cursor image in synchronization with a touch operation on the touch panel screen, and output the image on which the mouse cursor image is superimposed to the external display apparatus,
wherein the touch panel screen is transparent, functions as a touch screen display and as a touch pad which realizes a mouse operation equivalent function, by integrating with the display unit.

20. An information processing system comprising:
the operation apparatus according to claim 1;
a display apparatus;
a processing apparatus which converts the coordinate information outputted from the output unit into coordinate information in the display apparatus, and displays a cursor image at a coordinate position indicated by the coordinate information that was converted; and
a communication unit configured to communicate at least the coordinate information between the operation apparatus and the processing apparatus,
wherein when receiving the coordinate information and the height information (Z) from the output unit, the processing apparatus:
displays a first cursor image when the height information (Z) is a positive value of at least a set value;
displays a second cursor image when the height information (Z) is a zero value; and
displays a third cursor image when the height information (Z) is a positive value of less than the set value.
